(19) United States
(12) Patent Application Publication
(10) Pub. No.: US 2026/0242629 A1
(43) Pub. Date: Aug. 20, 2026

(54) INK JET RECORDING METHOD AND INK JET RECORDING APPARATUS

(71) Applicant: CANON KABUSHIKI KAISHA, Tokyo (JP)

(72) Inventors: TOMOAKI ISHII, Saitama (JP); KENICHI SHIIBA, Saitama (JP); MUTSUKI KOJIMA, Chiba (JP)

(21) Appl. No.: 19/543,074

(22) Filed: Feb. 18, 2026

(30) Foreign Application Priority Data
Feb. 18, 2025 (JP) 2025-024418
Feb. 9, 2026 (JP) 2026-019420

(51) Int. Cl. C09D 11/40; B41J 2/165

(52) U.S. Cl. CPC C09D 11/40; B41J 2/16508; B41P 2235/27

(57) ABSTRACT

Provided is a recording method for recording an image with a recording apparatus including: an ink set including a plurality of aqueous inks including a black ink; a recording head having an ejection orifice surface on which a plurality of ejection orifice arrays for ejecting each of the plurality of aqueous inks is arranged; a first cap that collectively covers the plurality of ejection orifice arrays and performs a recovery operation; and a second cap free from performing the recovery operation, the recording head being capped with the second cap during non-recording. A first ink out of the plurality of aqueous inks contains a pigment, a first solvent having a boiling point of 250° C. or more and a second solvent having a boiling point of less than 250° C., and the mass ratio of the first solvent to the second solvent is 1.0 times or more to 30.0 times or less.

### BACKGROUND

### Field of the Technology

The present disclosure relates to an ink jet recording method and an ink jet recording apparatus.

### Description of the Related Art

In recent years, an ink jet recording apparatus has been increasingly used not only for outputting a photographic image at home but also in a business field such as an office for an application of outputting an output, such as a document, a web page and an e-mail, at high speed. In such applications, an ink set including a plurality of aqueous inks including a black ink is used, and a water-soluble organic solvent having a low boiling point is sometimes used to enhance the quick drying property of the ink.

In addition, in order to stably record an image, an ink jet recording apparatus including a recovery mechanism that recovers the ejection state of an ink from an ejection orifice formed in a recording head is used as the ink jet recording apparatus. Specifically, there has been used a recording apparatus including a recovery mechanism that performs a recovery operation of sucking or pressurizing the ink under a state in which the ejection orifice surface of the recording head is capped. The ink jet recording apparatus used in the business field has been required to be downsized as compared to the related art. The downsizing of the recovery mechanism is effective for this purpose. The downsizing of the recovery apparatus can be achieved by utilizing a cap capable of collectively covering a plurality of ejection orifice arrays corresponding to a plurality of inks for forming an ink set.

Further, the ink jet recording apparatus has been required to be excellent in so-called sticking recovery property so that the ink can be normally ejected in order to record a high-quality image even when the apparatus is used after the lapse of a long period of time under a non-recording state. Typically, when the recording apparatus is not used for a long period of time, the ejection orifice surface of the recording head is covered with a cap to suppress the evaporation of the ink. However, an ink adhering to the inside of the cap due to a recovery operation or the like has a low concentration of a liquid component, and hence the ink deprives an ink having a high concentration of the liquid component in a flow path in the vicinity of the ejection orifice of the liquid component, and the ink in the vicinity of the ejection orifice sticks. Accordingly, the sticking recovery property may be lowered.

Hitherto, various proposals have been made to improve the sticking recovery property of the ink. For example, a recording apparatus in which the sticking recovery property is improved by using a cap different from a cap for performing a recovery operation has been proposed (Japanese Patent Laid-Open No. 2007-136772). In addition, there is a disclosure of a recording apparatus in which a cap for performing a suction recovery operation and a cap free from performing the suction recovery operation are mounted, and those caps are selectively used in accordance with the status of an error occurring during reciprocating scanning of a recording head (Japanese Patent Laid-Open No. 2024-075146). In addition, there is a disclosure of a configuration in which a cap for performing a suction recovery operation is used for some inks out of a plurality of kinds of inks to be mounted on a recording apparatus, and a cap free from performing the suction recovery operation is used for the other inks (Japanese Patent Laid-Open No. 2005-161834).

### SUMMARY

The inventors have investigated the sticking recovery property when an image is recorded with the recording apparatus proposed in each of Japanese Patent Laid-Open No. 2007-136772, Japanese Patent Laid-Open No. 2024-075146 and Japanese Patent Laid-Open No. 2005-161834. Specifically, first, an ink jet recording apparatus 1, including a cap free of performing any recovery operation (hereinafter also referred to as “second cap”), the cap being different from a cap for performing the recovery operation (hereinafter also referred to as “first cap”), was prepared. In addition, in order to downsize a recovery mechanism, an ink jet recording apparatus 2, including the above-mentioned first cap and second cap capable of collectively covering ejection orifice arrays corresponding to a plurality of inks for forming an ink set, was prepared. Then, an ink cartridge filled with each of a plurality of aqueous inks for forming an ink set to be described later was mounted on the ink jet recording apparatus, and the resultant was left to stand for a long period of time under a non-recording state. The plurality of inks for forming the ink set includes a black ink, and at least one kind of ink out of the plurality of inks contains a water-soluble organic solvent having a boiling point of less than 250° C. Then, the sticking recovery property when an image was recorded by ejecting each of the inks for forming the ink set after the standing was investigated. As a result, when the ink jet recording apparatus 1 was used, it was able to be recognized that the sticking recovery property was improved by capping the ejection orifice surface of the recording head with the second cap. However, when the ink jet recording apparatus 2 was used, in the case where the ejection orifice surface of the recording head was capped with the second cap, the sticking recovery property was improved to some extent as compared to that in the case where the ejection orifice surface is capped with the first cap. However, it has been found that the level does not reach a level required in recent years.

Accordingly, the present disclosure is directed to providing an ink jet recording method excellent in sticking recovery property of an ink, the method being capable of recording an image in which a change in color tone is suppressed even when a recording apparatus including a downsized recovery mechanism is used after the lapse of a long period of time under a non-recording state. The present disclosure is also directed to providing an ink jet recording apparatus to be used in the ink jet recording method.

That is, according to the present disclosure, there is provided an ink jet recording method including recording an image with an ink jet recording apparatus including: an ink set including a plurality of aqueous inks including a black ink; a recording head having an ejection orifice surface on which a plurality of ejection orifice arrays for ejecting each of the plurality of aqueous inks is arranged; a first cap configured to collectively cover the plurality of ejection orifice arrays on the ejection orifice surface and to perform a recovery operation of sucking or pressurizing the aqueous ink; and a second cap configured to collectively cover the plurality of ejection orifice arrays on the ejection orifice surface, the second cap being free from performing the recovery operation of sucking or pressurizing the aqueous ink, the recording head being capped with the second cap during non-recording, wherein a first ink that is at least one kind of aqueous ink out of the plurality of aqueous inks contains a pigment, a first water-soluble organic solvent having a boiling point of 250° C. or more and a second water-soluble organic solvent having a boiling point of less than 250° C., and wherein, in the first ink, a content (% by mass) of the first water-soluble organic solvent is 1.0 times or more to 30.0 times or less in terms of mass ratio with respect to a content (% by mass) of the second water-soluble organic solvent.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view for schematically illustrating an ink jet recording apparatus according to one embodiment of the present disclosure.

FIG. 1B is a sectional view for schematically illustrating the ink jet recording apparatus according to one embodiment of the present disclosure.

FIG. 2A is a perspective view for schematically illustrating an example of a recording head.

FIG. 2B is a view for schematically illustrating an example of the recording head, and is a plan view of a recording element substrate for forming the recording head.

FIG. 3 is a sectional view for schematically illustrating an example of the configuration of a recording head and a buffer tank.

FIG. 4A is a view for schematically illustrating an example of the configuration of a recovery unit, and is a sectional view of a first recovery unit.

FIG. 4B is a view for schematically illustrating an example of the configuration of the recovery unit, and is a sectional view of a second recovery unit.

### DESCRIPTION OF THE EMBODIMENTS

The present disclosure is described in more detail below by way of exemplary embodiments. In the present disclosure, when a compound is a salt, the salt is present in a state of dissociating into ions in an ink, but the expression “contains the salt” is used for convenience. In addition, an aqueous ink for ink jet is sometimes simply described as “ink”. Physical property values are values at normal temperature (25° C.) and normal pressure (1 atm) unless otherwise stated.

The inventors have conducted various investigations on an improvement in sticking recovery property when an ink jet recording apparatus including a cap capable of collectively covering ejection orifice arrays corresponding to a plurality of inks for forming an ink set is used after the lapse of a long period of time under a non-recording state. The term “ink set” as used herein means to a plurality of inks corresponding to a plurality of ejection orifice arrays collectively covered with one cap. Specifically, an ink cartridge filled with each of a plurality of inks for forming an ink set to be described later was mounted on an ink jet recording apparatus including a second cap free from performing any recovery operation, and the resultant was left to stand for a long period of time under a non-recording state. The plurality of inks for forming the ink set includes a black ink, and at least one kind of ink out of the plurality of inks contains a first water-soluble organic solvent having a boiling point of less than 250° C. and a second water-soluble organic solvent having a boiling point of 250° C. or more. Then, when the sticking recovery property when recording an image by ejecting each of the inks for forming the ink set after the standing was observed, it was found that the level reached a level required in recent years. However, it was found that the color tone of part of the writing-start of an image (a region recorded first) recorded after the lapse of a long period of time under a state in which the ejection orifice surface of the recording head was capped with the second cap was significantly different from the color tone of an image recorded before the lapse of the long period of time in some cases.

Such change in color tone of an image was a phenomenon occurring even under a state in which the lowering of the sticking recovery property did not matter, unlike a phenomenon in which the writing-start of the image became faint owing to the lowering of the sticking recovery property. In addition, the level of a problem was found to be high because the change in color tone was particularly liable to be visually recognized in an ink set including a black ink. When an image in which the change in color tone occurred was observed in detail, it was found that the color tone changed significantly owing to a change in ink dot size. The problem of the change in color tone is conceived to have occurred because, when a black ink is included, a lightness difference caused by a change in dot size of at least one kind of ink for forming the ink set is particularly liable to be visually recognized as compared to that of an image recorded by using an ink set free of a black ink. The inventors have inferred the cause of the change in dot size as described below.

When the recording head is left to stand for a long period of time under a state in which the ejection orifice surface of the recording head is capped with the second cap free from performing any recovery operation, evaporation of a liquid component of the ink in a flow path in the vicinity of the ejection orifice is suppressed as compared to that in a case where the ejection orifice surface is capped with the first cap that performs the recovery operation. However, the evaporation of the liquid component proceeds until the inside of the cap is saturated with the evaporated liquid component. A water-soluble organic solvent to be used for an aqueous ink typically has a vapor pressure lower than that of water. Accordingly, an ink droplet ejected from the ejection orifice of the recording head in this state is conceived to be in a state in which the content of the water-soluble organic solvent is relatively increased in accordance with the evaporation of water, which is a liquid having a high vapor pressure out of the liquid components. It is conceived that such ink droplet has a slower evaporation rate after its adhesion to a recording medium and takes longer time to be fixed to the recording medium, resulting in an enlarged dot size, as compared to those of an ink droplet having a high content of the liquid component before the lapse of a long period of time.

Under such inference, the inventors have made further investigations. As a result, it has been found that, when the following requirements (i) to (iii) are satisfied, an image in which a change in color tone is suppressed can be recorded while the sticking recovery property is improved even when an ink jet recording apparatus is used after the lapse of a long period of time under a non-recording state. Thus, the present disclosure has been reached. The inventors have inferred the reason why the above-mentioned effects are obtained by satisfying the requirements (i) to (iii) as described below.
(i) An ink jet recording apparatus in which a recording head is capped with a second cap during non-recording is used.
(ii) An ink set including a black ink is used, and a plurality of inks for forming the ink set includes a first ink containing a pigment, a first water-soluble organic solvent having a boiling point of 250° C. or more and a second water-soluble organic solvent having a boiling point of less than 250° C.
(iii) In the first ink, the content (% by mass) of the first water-soluble organic solvent is 1.0 times or more to 30.0 times or less in terms of mass ratio with respect to the content (% by mass) of the second water-soluble organic solvent.

When the recording head is capped with the second cap, the second water-soluble organic solvent (boiling point: less than 250° C.), which is easily evaporated, moves to the vicinity of the ejection orifice in the ink flow path of the recording head. At this time, it is conceived that the first water-soluble organic solvent also moves to the vicinity of the ejection orifice in the ink flow path because hydrophobic parts of the second water-soluble organic solvent and the first water-soluble organic solvent (boiling point: 250° C. or more) interact with each other. The second water-soluble organic solvent having moved to the vicinity of the ejection orifice is conceived to be likely to remain in the vicinity of the ejection orifice because the second water-soluble organic solvent interacts with the first water-soluble organic solvent and the ejection orifice surface is covered with the second cap, and hence the second water-soluble organic solvent becomes difficult to evaporate from the ejection orifice. At this time, when, in the first ink, the content (% by mass) of the first water-soluble organic solvent is 1.0 times or more to 30.0 times or less in terms of mass ratio with respect to the content (% by mass) of the second water-soluble organic solvent, a film-like water-soluble organic solvent layer is formed by the two kinds of water-soluble organic solvents in the vicinity of the ejection orifice. It is conceived that the evaporation of the liquid component from the ejection orifice is suppressed by the water-soluble organic solvent layer. An ink droplet ejected from the recording head in a state in which the evaporation of the liquid component from the ejection orifice is suppressed rapidly evaporates to be fixed to the recording medium after its adhesion to the recording medium. Accordingly, it is conceived that enlargement of the dot size is suppressed and the change in color tone is suppressed.

Meanwhile, when, in the first ink, the content (% by mass) of the first water-soluble organic solvent is more than 30.0 times in terms of mass ratio with respect to the content (% by mass) of the second water-soluble organic solvent, the suppressing effect on the change in color tone cannot be obtained. When the above-mentioned mass ratio is more than 30.0 times, the amount of the second water-soluble organic solvent is too small relative to the amount of the first water-soluble organic solvent. Accordingly, the film-like water-soluble organic solvent layer is not formed in the vicinity of the ejection orifice, and hence the evaporation of the liquid component from the ejection orifice proceeds. As a result, the fixation of the ink to the recording medium is delayed and the dot size is enlarged, and hence the change in color tone cannot be suppressed.

### <Ink Jet Recording Method and Ink Jet Recording Apparatus>

An ink jet recording method of the present disclosure is an ink jet recording method including recording an image with an ink jet recording apparatus including a recording head, a first cap and a second cap. The recording head is a member having an ejection orifice surface on which a plurality of ejection orifice arrays for ejecting each of a plurality of aqueous inks including a black ink in an ink set including the plurality of aqueous inks is arranged. The first cap is a member capable of collectively covering the plurality of ejection orifice arrays on the ejection orifice surface for performing a recovery operation of sucking or pressurizing the aqueous ink. The second cap is a member capable of collectively covering the plurality of ejection orifice arrays on the ejection orifice surface, the second cap being free from performing the recovery operation of sucking or pressurizing the aqueous ink. The ink jet recording apparatus is an apparatus in which the recording head is capped with the second cap during non-recording. A first ink that is at least one kind of aqueous ink out of the plurality of aqueous inks contains a pigment, a first water-soluble organic solvent having a boiling point of 250° C. or more and a second water-soluble organic solvent having a boiling point of less than 250° C. In addition, in the first ink, the content (% by mass) of the first water-soluble organic solvent is 1.0 times or more to 30.0 times or less in terms of mass ratio with respect to the content (% by mass) of the second water-soluble organic solvent.

In addition, an ink jet recording apparatus of the present disclosure is an apparatus to be used in an ink jet recording method including recording an image, the apparatus including a recording head, a first cap and a second cap. The recording head is a member having an ejection orifice surface on which a plurality of ejection orifice arrays for ejecting each of a plurality of aqueous inks including a black ink in an ink set including the plurality of aqueous inks is arranged. The first cap is a member capable of collectively covering the plurality of ejection orifice arrays on the ejection orifice surface for performing a recovery operation of sucking or pressurizing the aqueous ink. The second cap is a member capable of collectively covering the plurality of ejection orifice arrays on the ejection orifice surface, the second cap being free from performing the recovery operation of sucking or pressurizing the aqueous ink. The ink jet recording apparatus of the present disclosure is an apparatus in which the recording head is capped with the second cap during non-recording. A first ink that is at least one kind of aqueous ink out of the plurality of aqueous inks contains a pigment, a first water-soluble organic solvent having a boiling point of 250° C. or more and a second water-soluble organic solvent having a boiling point of less than 250° C. In addition, in the first ink, the content (% by mass) of the first water-soluble organic solvent is 1.0 times or more to 30.0 times or less in terms of mass ratio with respect to the content (% by mass) of the second water-soluble organic solvent.

### (Ink Jet Recording Apparatus)

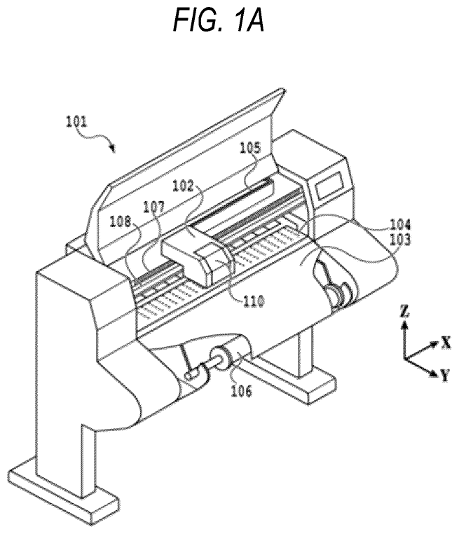

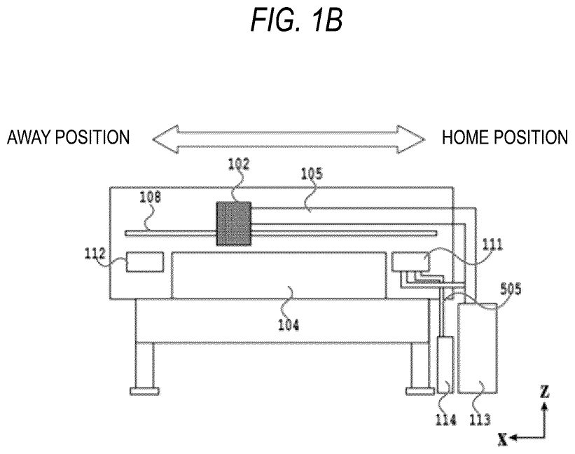

FIG. 1A and FIG. 1B are views for schematically illustrating the ink jet recording apparatus according to one embodiment of the present disclosure. FIG. 1A is a perspective view and FIG. 1B is a sectional view. An ink jet recording apparatus 101 of the embodiment illustrated in FIG. 1A and FIG. 1B is a recording apparatus of a so-called serial scanning type, and is an apparatus that records an image by scanning a recording head 110 in an X direction (scanning direction) perpendicular to a Y direction (conveying direction) of a recording medium 103. The recording medium 103 is conveyed in the Y direction with a spool 106 holding the recording medium 103 by a conveying roller driven via a gear by a conveying motor. Meanwhile, at a predetermined conveying position, a carriage unit 102 is reciprocally scanned (reciprocating movement) above the recording medium 103 along a guide shaft 108 extending in the X direction by a carriage motor. The recording head 110 to be described later is mounted on the carriage unit 102. In addition, in the process of the scanning, an ejection operation of ejecting an ink from the ejection orifice of the recording head 110 is performed at a timing based on a position signal obtained by an encoder 107, and an image for a certain band corresponding to an arrangement range of the ejection orifices is recorded. After that, the recording medium 103 is conveyed, and an image for the next band is further recorded. The fed recording medium 103 is sandwiched and conveyed by a sheet feed roller and a pinch roller, and is guided to a recording position (scanning region of the recording head) on a platen 104. As the recording medium 103, for example, a recording medium having no coating layer, such as plain paper, uncoated paper, and synthetic paper, and a recording medium having a coating layer, such as coated base paper, glossy paper, and art paper, may be used, provided that they have ink absorbency (permeability). In particular, a recording medium having paper substrate is preferable.

The recording head 110 has an ejection orifice surface on which an ejection orifice array for ejecting an ink is arranged. A recording head of a serial type (serial head) or a recording head of a line type (line head) may be used as the recording head. Examples of a method of ejecting the ink from a recording head of an ink jet system may include a method including applying mechanical energy to the ink and a method including applying thermal energy to the ink. Of those, a method of ejecting the ink by applying thermal energy to the ink is preferably adopted.

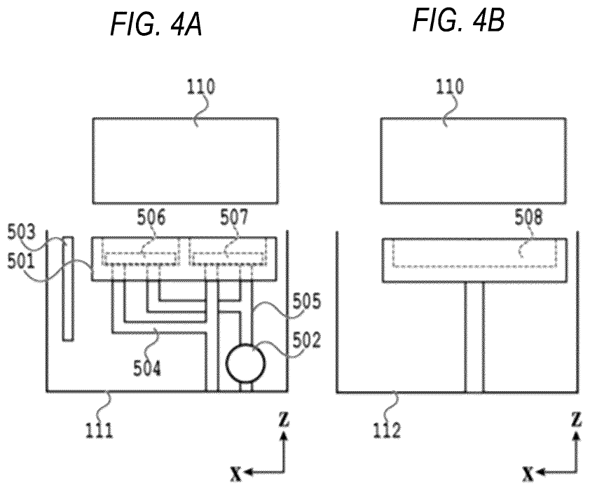

Typically, under an idle state in which recording by the recording head 110 is not performed, the ejection orifice surface of the recording head 110 is covered with a cap 508 (FIG. 4B) arranged in a second recovery unit 112 to be described later. When a recording operation is started, the cap 508 is removed to open the ejection orifice surface, and the carriage unit 102 on which the recording head 110 is mounted is brought into a scannable state. Then, after data for one scan has been accumulated in a buffer, the carriage unit 102 is scanned by the carriage motor, and recording is performed as described above. A carriage belt may be used in transmission of a driving force from the carriage motor to the carriage unit 102. Instead of the carriage belt, for example, any other driving method such as a mechanism including a lead screw rotationally driven by a carriage motor and extending in the X direction and an engagement part arranged on the carriage unit 102 and engaging with a groove of the lead screw may also be used. The ink is supplied to the recording head 110 via a supply tube 105 and the carriage unit 102 from an ink cartridge mounted on an ink cartridge unit 113 arranged inside the main body or externally. In addition, the ink may be supplied from the ink cartridge to the recording head 110 by using a pressure unit. Further, the ink may be supplied to the recording head 110 by capping the ejection orifice surface of the recording head 110 with a cap 501 (FIG. 4A) of a first recovery unit 111 and operating a suction pump to set the inside of the cap 501 to negative pressure to suck the ink. A recording head capable of ejecting inks of a plurality of colors is mounted on the carriage.

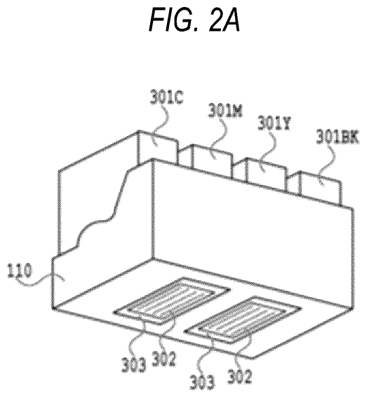

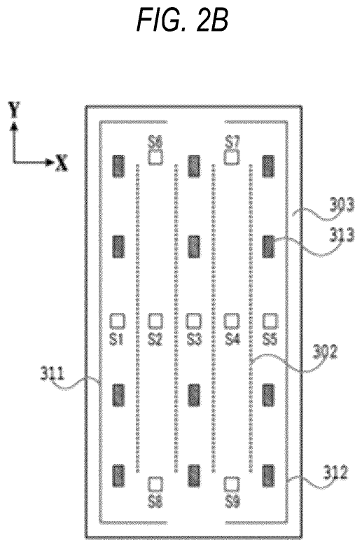

FIG. 2A and FIG. 2B are views for schematically illustrating an example of a recording head. FIG. 2A is a perspective view and FIG. 2B is a plan view of a recording element substrate for forming the recording head. The recording head 110 illustrated in FIG. 2A includes independent buffer tanks 301C, 301M, 301Y and 301BK corresponding to inks of four colors of cyan, magenta, yellow and black. In FIG. 2A, the buffer tanks are illustrated so as to be visible for description, but the buffer tanks are typically stored inside the recording head 110. On the lower surface of the recording head 110, a recording element substrate 303 in which ejection orifice arrays corresponding to the respective inks are formed is arranged. In the recording element substrate 303, 1,024 ejection orifices 302 are formed side by side in four rows per color at intervals of 1,200 dpi, and the inks of four colors can be ejected by one recording element substrate. The ejection orifice arrays corresponding to the ink of one color do not need to be arranged on the same straight line. For example, 512 ejection orifice arrays may be arranged alternately (staggered) one by one at intervals of 600 dpi, for a total of four rows. The number and arrangement of the ejection orifice arrays and the number of ink colors are not limited to the foregoing.

As illustrated in FIG. 2B, temperature sensors S6, S7, S8 and S9 formed of diodes for detecting the temperature of the recording element substrate 303 are arranged at ends in the arrangement direction of the ejection orifices 302 of the recording element substrate 303. The temperature sensors S6, S7, S8 and S9 are arranged at positions distant by about 0.2 mm from the outermost ejection orifice position of the ejection orifice array in the arrangement direction (Y direction) of the ejection orifices 302. In addition, the temperature sensors S6, S7, S8 and S9 are arranged at intermediate positions between two ejection orifice arrays in a main scanning direction (X direction). Temperature sensors S1, S2, S3, S4 and S5 formed of diodes for detecting the central portion temperature of the recording element substrate 303 are arranged at a central portion in the arrangement direction of the ejection orifices 302. Those temperature sensors S1, S2, S3, S4 and S5 are also arranged at intermediate positions sandwiched between two ejection orifice arrays. Heat retention heaters 311 and 312 are arranged so as to surround the ejection orifice arrays, and are arranged 1.2 mm outside the outermost ejection orifice arrays in the main scanning direction and about 0.2 mm outside the temperature sensors S6, S7, S8 and S9. The horizontal×vertical size of the recording element substrate 303 is about 9.55 mm×about 39.0 mm. In addition, a plurality of heating elements 313 capable of heating the recording element substrate 303 is arranged on the recording element substrate 303. When those heating elements 313 are operated, the viscosity change of the ink in the recording head 110 can be suppressed, and the temperature and viscosity of the ink can be maintained constant without being affected by an environmental temperature. A driver (driving unit) (not shown) is arranged in the recording head 110. The driver is connected to each of the heating elements 313 and is configured to control the driving current of the heating elements 313 to ON or OFF. The size of the recording element substrate and the arrangement of the heaters are not limited to the foregoing.

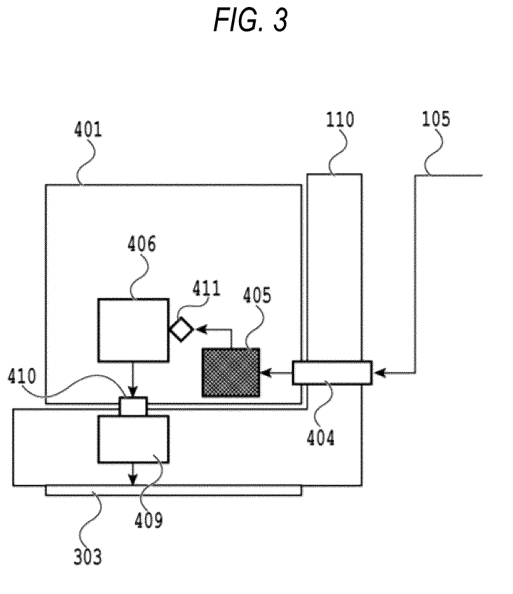

FIG. 3 is a sectional view for schematically illustrating an example of the configuration of a recording head and a buffer tank. A flow path for one color is schematically illustrated in FIG. 3, but as described above, buffer tanks and flow paths for four colors of cyan, magenta, yellow and black are formed in one recording head 110. The supply tube 105 is connected to a joint 404 of the recording head 110 through the inside of the carriage unit 102 (FIG. 1A and FIG. 1B) and communicates to a buffer tank 401. The ink supplied from the ink cartridge passes through a filter 405 and the flow path of the buffer tank 401, and reaches a first pressure chamber 406. A valve 411 that opens when a predetermined negative pressure is reached is arranged on the inlet of the first pressure chamber 406. The valve 411 is arranged in a flow path between the filter 405 and the first pressure chamber 406. An ink is supplied from the first pressure chamber 406 to the supply flow path of one or a plurality of ejection orifice arrays arranged in the recording element substrate 303 via a joint 410 and a common supply flow path 409 formed in the recording head 110.

In the ink jet recording method of the present disclosure, an ink jet recording apparatus including a first cap and a second cap is used. The first cap is a cap capable of collectively covering the ejection orifice surface of a recording head for performing a recovery operation of sucking or pressurizing the ink. Meanwhile, the second cap is a cap capable of collectively covering the ejection orifice surface of the recording head during non-recording, the cap being free from performing the recovery operation of sucking or pressurizing the ink. That is, the first cap is a cap that performs a recovery operation of discharging the ink in the recording head, and the second cap is a cap free from performing the recovery operation of discharging the ink in the recording head. The configuration of a first recovery unit having the first cap and the configuration of a second recovery unit having the second cap are each described below.

FIG. 4A and FIG. 4B are views for schematically illustrating an example of the configuration of a recovery unit. FIG. 4A is a sectional view of a first recovery unit and FIG. 4B is a sectional view of a second recovery unit. As illustrated in FIG. 4A, a first recovery unit 111 includes a cap 501 serving as a first cap and a maintenance mechanism for maintaining a wet state in the cap 501. The maintenance mechanism includes a cleaning unit for cleaning the ejection orifice surface of the recording head 110 through use of a suction pump 502 (negative pressure generating unit), a washing liquid storage portion (not shown) (supply unit) and a wiper 503. The cap 501 is a member that covers the ejection orifice surface of the recording head 110. When the suction pump 502 is operated, it is possible to generate negative pressure in the recording head 110 under a state in which the cap 501 covers the ejection orifice surface, and the ink can be sucked from the recording head 110. The wiper 503 is a member that wipes the ejection orifice surface of the recording head 110. The washing liquid storage portion is a portion for supplying a washing liquid into the cap 501.

The first recovery unit 111 is arranged at a position facing the recording head 110 of the carriage unit 102 (FIG. 1A and FIG. 1B) stopped at a home position. The home position means the position of one end (right end) of the carriage unit 102 in the main scanning direction as illustrated in FIG. 1B. However, this home position is merely an example, and the position of the other end (left end) of the carriage unit 102 in the main scanning direction may be the home position. The cap 501 is supported by an elevating mechanism (not shown) so as to be capable of moving up and down, and moves between an up position and a down position. At the up position, the cap 501 abuts against the recording head 110 and caps the ejection orifice surface of the recording head 110. The ink can be sucked from the recording head 110 by driving the suction pump 502 under a state in which the ejection orifice surface of the recording head 110 is capped with the cap 501.

Tubes 504 and 505 are connected to the cap 501. The tube 504 is connected to the washing liquid storage portion mounted on the ink cartridge unit 113 (FIG. 1B) arranged inside the main body or externally for washing the cap 501 and the recording head 110. The washing liquid is supplied into the cap 501 via the tube 504 by a pressure unit in order to dilute an ink residue in the cap 501 to suppress sticking. The washing liquid is mainly supplied after preliminary ejection for ejecting the ink from the recording head 110 for recovery or a suction operation of the ejection orifice by the suction pump 502. However, in order to maintain a wet state, the washing liquid may be supplied at regular time intervals. The tube 505 is connected to a waste liquid storage portion 114 (FIG. 1B), and the ink and the washing liquid held in the cap 501 (inside the cap to which the washing liquid is supplied) can be discharged by using the suction pump 502.

Absorbers 506 and 507 are arranged in the cap 501. Accordingly, the cap 501 can hold certain amounts of the ink discharged by the preliminary ejection and the suction operation, and the washing liquid supplied from the washing liquid storage portion. In addition, the cap 501 is positioned at the down position to avoid interference with the recording head 110 moving together with the carriage unit 102 during a recording operation. Under a state in which the cap 501 is positioned at the down position, the recording head 110 can perform preliminary ejection onto the cap 501 when moving to a position facing the cap 501.

The wiper 503 is formed of, for example, an elastic member such as a rubber or a porous material that absorbs an ink. The wiper 503 is reciprocally moved in the direction indicated by the arrow Z between a wiping position and a retracted position by a well-known unit in order to remove foreign matter such as an ink residue adhering to the ejection orifice surface. During non-wiping, the wiper 503 is positioned at the retracted position as illustrated in FIG. 4A. Meanwhile, during a wiping operation, the wiper 503 moves to the wiping position, and in this state, the carriage unit 102 (FIG. 1A and FIG. 1B) moves in the direction indicated by the arrow X. As a result, the wiping operation is performed under a state in which the wiper 503 abuts against the ejection orifice surface of the recording head 110. In addition, the wiper 503 may be a vacuum wiper capable of sucking the ejection orifice surface. The wiper 503 illustrated in FIG. 4A is configured to perform a wiping operation only when moving in one direction, but the wiper 503 may be configured to perform the wiping operation when moving in both directions. Further, the wiping direction of the wiper 503 illustrated in FIG. 4A is perpendicular to the arrangement direction of the ejection orifice arrays of the recording head 110, but the wiper 503 may be configured to move in the arrangement direction of the ejection orifice arrays.

When the suction pump 502 is driven under a state in which the cap 501 covers the ejection orifice surface of the recording head 110 and forms a closed space, negative pressure is generated in the closed space, and a suction operation of sucking the ink from the recording head 110 can be performed. That is, the suction pump 502 acts as a negative pressure generating unit. The suction operation is performed when the ink is loaded from an ink cartridge into the recording head 110 (at the time of initial loading) or when dust, sticks, bubbles and the like inside the recording head are removed by suction (at the time of suction recovery). A tube pump or the like may be used as the suction pump 502. The tube pump includes, for example, a holding part in which a curved surface part for holding (at least part of) the tube 505 along the tube is formed, a roller capable of pressing the held tube 505 and a roller support part for rotatably supporting the roller. The tube pump rotates the roller while crushing the tube 505 by rotating the roller support part in a predetermined direction. As a result, negative pressure is generated inside the cap 501, and the ink can be sucked from the recording head 110 and discharged. A recovery operation by suction has been described above, but the ink may be discharged into the cap 501 by pressurizing the inside of the recording head 110 through use of a pressure unit arranged upstream of the recording head 110 (recovery operation by pressurization).

The discharged ink is discharged to a waste ink absorber or a waste ink collection bottle via the tube 505. In addition, in the case where preliminary ejection is performed onto the cap 501 by the recording head 110, when the ink received by the cap 501 through the preliminary ejection is discharged, the suction operation is also performed. That is, in the case where the ink held in the cap 501 through the preliminary ejection reaches a predetermined amount, when the suction pump 502 is driven, the ink held in the cap 501 may be discharged to the waste liquid storage portion 114 via the tube 505. Further, the suction operation is also performed in the discharge of the washing liquid supplied from the washing liquid cartridge via the tube 504. In the case where the washing liquid held in the cap 501 reaches a predetermined amount, when the suction pump 502 is driven, the washing liquid held in the cap 501 may be discharged to the waste liquid storage portion 114 via the tube 505.

As illustrated in FIG. 4B, the second recovery unit 112 includes a cap 508 serving as a second cap capable of collectively covering the ejection orifice surface of the recording head 110, and is substantially free of any configuration and function for performing a recovery operation of sucking or pressurizing the ink. The second recovery unit 112 is arranged at a position facing the recording head 110 of the carriage unit 102 (FIG. 1A and FIG. 1B) stopped at an away position. The away position means the position of the other end (left end) of the carriage unit 102 in the main scanning direction as illustrated in FIG. 1B. However, this away position is merely an example, and the position of one end (right end) of the carriage unit 102 in the main scanning direction may be the away position. The cap 508 is supported by an elevating mechanism (not shown) so as to be capable of moving up and down, and moves between an up position and a down position. At the up position, the cap 508 abuts against the recording head 110 and covers (caps) the ejection orifice surface of the recording head 110. When the ejection orifice surface of the recording head 110 is covered with the cap 508, it is possible to suppress the drying of the ejection orifice of the recording head 110 and the evaporation of the ink during a non-recording operation. Meanwhile, unlike the cap 501, the cap 508 is free of a suction pump and a washing liquid supply path. Accordingly, the preliminary ejection of the recording head 110 and the recovery operation by suction or pressurization are not performed in the cap 508.

The arrangement locations of the first recovery unit 111 and the second recovery unit 112 are not limited to the embodiment illustrated in FIG. 4A and FIG. 4B. For example, the first recovery unit 111 may be arranged at the away position, and the second recovery unit 112 may be arranged at the home position. In particular, the first recovery unit 111 and the second recovery unit 112 are preferably arranged so as to face each other (at both ends) with the conveying path of the recording medium 103 (FIG. 1A) interposed therebetween. In addition, three or more recovery units (caps) may be arranged.

### (Ink Set)

The ink set to be used in the recording method of the present disclosure is formed of a plurality of inks including a black ink. In addition, a first ink that is at least one kind of ink out of the plurality of inks contains a pigment, a first water-soluble organic solvent having a boiling point of 250° C. or more and a second water-soluble organic solvent having a boiling point of less than 250° C. Further, in the first ink, the content (% by mass) of the first water-soluble organic solvent is 1.0 times or more to 30.0 times or less in terms of mass ratio with respect to the content (% by mass) of the second water-soluble organic solvent.

The plurality of inks only needs to include a black ink, and the colors (hues) of the other inks are not limited, but a cyan ink, a magenta ink and a yellow ink are preferably included. The ink set is preferably formed of four kinds of inks, that is, a black ink, a cyan ink, a magenta ink and a yellow ink. In addition, the first ink containing the first water-soluble organic solvent and the second water-soluble organic solvent may be a black ink or any other ink. Matters not related to the ink color or whether the ink is the first ink are described below without distinction between the kinds of the inks.

### [Pigment]

The ink contains a pigment. The content (% by mass) of the pigment in the ink is preferably 5.0% by mass or more, more preferably 6.0% by mass or more with respect to the total mass of the ink. When the content of the pigment is 5.0% by mass or more, an image having high color development can be recorded. When the content of the pigment is more than 10.0% by mass, the ejection state of the ink may become slightly unstable. The content (% by mass) of the pigment in the ink is preferably 10.0% by mass or less with respect to the total mass of the ink.

Specific examples of the pigment may include: inorganic pigments, such as carbon black and titanium oxide; and organic pigments, such as azo, phthalocyanine, quinacridone, isoindolinone, imidazolone, diketopyrrolopyrrole and dioxazine pigments. The pigments may be used alone or in combination thereof. The pigment of the black ink preferably contains carbon black.

A resin-dispersed pigment using a resin as a dispersant, a self-dispersible pigment, which has a hydrophilic group bonded to its particle surface, or the like may be used as a dispersion system for the pigment. In addition, a resin-bonded pigment having a resin-containing organic group chemically bonded to its particle surface, a microcapsule pigment, which contains a particle whose surface is covered with, for example, a resin, or the like may be used. Pigments different from each other in dispersion system out of those pigments may be used in combination. Of those, a self-dispersible pigment, which has a hydrophilic group bonded to its particle surface, or a system of dispersing a pigment by the action of a resin dispersant physically adsorbed onto the particle surface of the pigment (e.g., a water-soluble resin including a unit having an acid group and a unit free of an acid group) (resin-dispersed pigment) is preferable. In particular, the black ink preferably contains a self-dispersible pigment having an anionic group bonded to the particle surface of the pigment (carbon black) directly or via another atomic group. In addition, color inks, such as cyan, magenta and yellow, each preferably contain a pigment dispersed by a resin dispersant (resin-dispersed pigment).

The resin dispersant for dispersing the pigment in an aqueous medium may be a resin having any configuration as long as the resin dispersant can be used for an aqueous ink. Examples thereof may include an acrylic resin, a urethane resin, a polyamide resin, a polyester resin, a polyvinyl alcohol resin and a polyolefin resin. Of those, an acrylic resin is preferable.

### [Water-Soluble Organic Solvent]

The first ink contains a first water-soluble organic solvent having a boiling point of 250° C. or more and a second water-soluble organic solvent having a boiling point of less than 250° C. In the first ink, the content (% by mass) of the first water-soluble organic solvent is 1.0 times or more to 30.0 times or less, preferably 5.0 times or more to 27.0 times or less in terms of mass ratio with respect to the content (% by mass) of the second water-soluble organic solvent. Any ink other than the first ink may also contain the first water-soluble organic solvent having a boiling point of 250° C. or more and the second water-soluble organic solvent having a boiling point of less than 250° C., and also preferably satisfies the above-mentioned mass ratio. Further, each of the plurality of inks for forming the ink set is preferably the “first ink” containing the first water-soluble organic solvent and the second water-soluble organic solvent, and satisfying the above-mentioned mass ratio.

Examples of the first water-soluble organic solvent may include trimethylolpropane (296° C.), glycerin (290° C.), triethylene glycol (285° C.), triethylene glycol monobutyl ether (278° C.), polyethylene glycol having a number-average molecular weight of 200 (250° C.) and polyethylene glycol having a number-average molecular weight of 600 (250° C.). The number in the parentheses indicates the boiling point of each water-soluble organic solvent at 1 atm. The boiling point of the first water-soluble organic solvent is preferably 350° C. or less. For the boiling points of the main water-soluble organic solvents, reference has been made to values described in Chemical Handbook Fundamentals I, revised 5th edition, edited by The Chemical Society of Japan, 2004. The first ink may contain one kind or two or more kinds of first water-soluble organic solvents. Of the first water-soluble organic solvents, a polyethylene glycol having a number-average molecular weight of 200 or more to 1,000 or less is preferably used.

In the first ink, the content (% by mass) of the first water-soluble organic solvent is preferably 2.1 times or more to 10.0 times or less in terms of mass ratio with respect to the content (% by mass) of the pigment. When the above-mentioned mass ratio is 2.1 times or more, aggregation of the pigment occurring when the recording apparatus is left to stand for a long period of time is easily suppressed, and hence the sticking recovery property can be further improved. When the above-mentioned mass ratio is more than 10.0 times, the amount of the first water-soluble organic solvent relative to the pigment is too large, and hence the dispersion state of the pigment is liable to become unstable and the ejectability of the ink may be slightly lowered.

The content (% by mass) of the first water-soluble organic solvent in the first ink is preferably 10.0% by mass or more to 40.0% by mass or less, more preferably 20.0% by mass or more to 30.0% by mass or less with respect to the total mass of the ink.

Examples of the second water-soluble organic solvent may include diethylene glycol (246° C.), 2-pyrrolidone (245° C.), dipropylene glycol (232° C.), 2-ethyl-1,3-hexanediol (244° C.), 2-methyl-1,3-propanediol (230° C.), 1,2-hexanediol (224° C.), 1,3-butanediol (207° C.), diethylene glycol monoethyl ether (202° C.), ethylene glycol (197° C.), diethylene glycol monomethyl ether (194° C.), 1,2-butanediol (193° C.) and propylene glycol (122° C.). The number in the parentheses indicates the boiling point of each water-soluble organic solvent at 1 atm. The boiling point of the second water-soluble organic solvent is preferably more than 100° C. For the boiling points of the main water-soluble organic solvents, reference has been made to values described in Chemical Handbook Fundamentals I, revised 5th edition, edited by The Chemical Society of Japan, 2004. The ink may contain one kind or two or more kinds of second water-soluble organic solvents. Of the second water-soluble organic solvents, an alkanediol having 4 or more carbon atoms is preferably used.

The content (% by mass) of the second water-soluble organic solvent in the first ink is preferably 1.0% by mass or more to 10.0% by mass or less with respect to the total mass of the ink.

Typically, the term “water-soluble organic solvent” means a liquid, but in the present disclosure, a compound that is a solid at 25° C. (normal temperature) is also encompassed in the water-soluble organic solvent. Examples of the water-soluble organic solvent that is widely used for an aqueous ink and is a solid at 25° C. may include 1,6-hexanediol, trimethylolpropane, ethylene urea, urea and a polyethylene glycol having a number-average molecular weight of 1,000 or more.

### [Water]

The ink to be used in the recording method of the present disclosure is an aqueous ink containing at least water as an aqueous medium. Deionized water (ion-exchanged water) is preferably used as the water. The content (% by mass) of the water in the aqueous ink is preferably 10.0% by mass or more to 90.0% by mass or less, more preferably 50.0% by mass or more to 90.0% by mass or less with respect to the total mass of the ink.

### [Other Resin]

The ink may contain any resin (water-soluble resin or resin particle) other than the resin dispersant suitable for dispersing the pigment. The other resin may be a resin having any configuration as long as the resin can be used for an aqueous ink. Examples thereof may include an acrylic resin, a urethane resin, a polyamide resin, a polyester resin, a polyvinyl alcohol resin and a polyolefin resin. At least one kind of ink for forming the ink set preferably contains a resin particle formed of an acrylic resin out of those resins. The content (% by mass) of the other resin in the ink is preferably 0.1% by mass or more to 10.0% by mass or less, more preferably 1.0% by mass or more to 9.0% by mass or less with respect to the total mass of the ink.

### [Other Component]

The ink may contain an organic compound that is a solid at normal temperature, such as trimethylolethane or trimethylolpropane, or a nitrogen-containing compound, such as urea or ethylene urea, as required in addition to the above-mentioned components. In addition to the above-mentioned components, various additives, such as a surfactant, a pH adjuster, a defoaming agent, an antirust agent, a preservative, an antifungal agent, an antioxidant, a reduction inhibitor, an evaporation accelerator and a chelating agent, may each be further incorporated into the ink as required. In the present disclosure, each of those additives has a relatively small effect on the effects of the present disclosure because of its small content. Accordingly, the additives are not targets for considering the boiling point as a water-soluble organic solvent.

Examples of the surfactant may include a cationic surfactant, an anionic surfactant, an amphoteric surfactant and a nonionic surfactant. Examples of the nonionic surfactant may include a hydrocarbon-based nonionic surfactant, a fluorine-based nonionic surfactant and a silicone-based surfactant.

### [Physical Properties of Ink]

The viscosity of the ink at 25° C. is preferably 1.0 mPa·s or more to 10.0 mPa·s or less, more preferably 5.0 mPa·s or more to 10.0 mPa·s or less. The viscosity of the ink may be measured with a viscometer (e.g., product name: “RE80 type viscometer”, manufactured by Toki Sangyo Co., Ltd.).

The surface tension (static surface tension) of the ink at 25° C. is preferably 10.0 mN/m or more to 50.0 mN/m or less. In addition, the surface tension is more preferably 20.0 mN/m or more to 40.0 mN/m or less, particularly preferably 20.0 mN/m or more to 35.0 mN/m or less. The static surface tension of the ink may be measured with a Wilhelmy-type surface tensiometer (e.g., product name: “Automatic Surface Tensiometer CBVP-Z”, manufactured by Kyowa Interface Science Co., Ltd.). The pH of the ink at 25° C. is preferably 5.0 or more to 10.0 or less, more preferably 7.0 or more to 9.5 or less. The pH of the ink may be measured with a common pH meter including a glass electrode or the like.

### (Relationship Between Inks for Forming Ink Set)

[When Difference in Mass Ratio in Inks for Forming Ink Set is More than 5.0 Times]

When a difference in mass ratio of the content (% by mass) of the first water-soluble organic solvent to the content (% by mass) of the second water-soluble organic solvent in at least one combination out of the plurality of inks is more than 5.0 times, the lightness of the ink having the smaller mass ratio is preferably higher. As described above, when the above-mentioned difference in mass ratio is more than 5.0 times, a change in color tone is liable to be visually recognized. The ink having the smaller mass ratio has a smaller amount of the first water-soluble organic solvent at the tip of the ejection orifice after capping for a long period of time than that of the ink having the larger mass ratio, and hence the evaporation of the liquid component easily proceeds. Accordingly, it is conceived that the degree of dot enlargement in the ink having the smaller mass ratio is more liable to change. Here, when attention is focused on the visibility of the change in color tone of an image, the change in color tone is conceived to be less visually recognized when an ink having high lightness is used than that when an ink having low lightness is used. For this reason, in the case of a combination of inks in which the above-mentioned difference in mass ratio is more than 5.0, the lightness of the ink having the smaller mass ratio is preferably higher because the change in color tone of a recorded image is less visually recognized. Of those, when a difference between the maximum value and minimum value of the mass ratios of the content (% by mass) of the first water-soluble organic solvent to the content (% by mass) of the second water-soluble organic solvent of the plurality of inks is more than 5.0 times, the lightness of the ink having the smallest mass ratio is preferably highest.

The lightness of the ink is represented by an L* value in an L*a*b* color system, which is calculated by measuring a diluted solution of the ink. The L* value of the ink (diluted solution) may be measured and calculated in accordance with the following procedure. First, in the case of a chromatic ink, such as cyan, magenta or yellow, a diluted solution is obtained by dilution with water (ion-exchanged water or the like) so that an absorbance at the maximum absorption wavelength in the wavelength range of from 380 nm to 780 nm becomes 1. In addition, in the case of an achromatic ink such as black, a diluted solution is obtained by dilution with water (ion-exchanged water or the like) so that an absorbance at a wavelength of 550 nm becomes 1. Next, the resultant diluted solution is loaded into a quartz glass cell having an optical path length of 10 mm, and an absorption spectrum in the wavelength region of from 200 nm to 800 nm is measured with a spectrophotometer. For example, a product available under the product name “UH3900” (manufactured by Hitachi High-Tech Corporation) may be used as the spectrophotometer. The L* value may be calculated from the measured absorption spectrum of the diluted solution.

### [When Difference in Mass Ratio in Inks for Forming Ink Set is 5.0 Times or Less]

A difference in mass ratio of the content (% by mass) of the first water-soluble organic solvent to the content (% by mass) of the second water-soluble organic solvent in at least one combination of the plurality of inks is preferably 5.0 times or less. When the above-mentioned difference in mass ratio is large, an image is recorded under a state in which the evaporation rates of the liquid component of the respective inks after standing for a long period of time in a capped state are significantly different. For this reason, it is conceived that the degrees of ink dot enlargement differ greatly, and the change in color tone is more liable to be visually recognized. Meanwhile, the above-mentioned difference in mass ratio is preferably 5.0 times or less because the change in color tone is less liable to be visually recognized. In particular, the difference between the maximum value and minimum value of the mass ratios of the content (% by mass) of the first water-soluble organic solvent to the content (% by mass) of the second water-soluble organic solvent of the plurality of inks is more preferably 5.0 times or less.

### EXAMPLES

The present disclosure is described in more detail below by way of Examples and Comparative Examples. The present disclosure is by no means limited to Examples below within a range not departing from the gist of the present disclosure. “Part(s)” and “%” with regard to the description of the amounts of components are by mass unless otherwise stated.

### <Preparation of Pigment Dispersion Liquid>

### (Pigment Dispersion Liquid 1)

A solution obtained by dissolving 5.0 g of concentrated hydrochloric acid in 5.5 g of water was cooled to 5° C., and in this state, 1.6 g of 4-aminophthalic acid (treating agent) was added thereto. A container containing the solution was placed in an ice bath. While the temperature of the solution was held at 10° C. or less under stirring, a solution obtained by dissolving 1.8 g of sodium nitrite in 9.0 g of ion-exchanged water at 5° C. was added thereto. After stirring for 15 minutes, 6.0 g of carbon black (specific surface area: 260 m²/g) was added under stirring, and the mixture was further stirred for 15 minutes to provide a slurry. The resultant slurry was filtered with filter paper (product name: “Standard filter paper No. 2”, manufactured by Advantec), and then the particle was sufficiently washed with water and dried in an oven at 110° C. After a counter ion had been changed from a sodium ion to a potassium ion by an ion exchange method, an appropriate amount of ion-exchanged water was added to adjust a pigment content. Thus, a pigment dispersion liquid 1, which had a pigment content of 20.0% and contained a self-dispersible pigment in which a phthalic acid group whose counter ion was a potassium ion [—C₆H₄—(COOK)₂] was bonded to the particle surface of the carbon black, was obtained.

### (Pigment Dispersion Liquids 2 to 5)

Respective components whose kinds and amounts (unit: parts) were shown in Table 1 and 85 parts of zirconia beads each having a diameter of 0.3 mm were loaded into a batch-type vertical sand mill (manufactured by Aimex Co., Ltd.), and the components were dispersed for 3 hours while being cooled with water. After that, the resultant was centrifuged so that a non-dispersed material containing a coarse particle was removed. Next, the residue was filtered with a cellulose acetate filter (manufactured by Advantec) having a pore size of 3.0 μm under pressure to prepare each of pigment dispersion liquids 2 to 5. A 20.0% aqueous solution of an acrylic resin obtained by neutralizing a styrene-acrylic acid copolymer with potassium hydroxide in an equimolar amount to its acid value, followed by dilution with water, was used as an aqueous solution of an acrylic resin. The acid value of the styrene-acrylic acid copolymer was 170 mgKOH/g and the weight-average molecular weight thereof was 8,000. The details of the respective components in Table 1 are shown below.
Carbon black (product name: “BLACK PEARLS 880”, manufactured by Cabot Corporation)
C.I. Pigment Blue 15:3 (product name: “Hostaperm Blue B2G”, manufactured by Heubach)
Magenta solid solution pigment (solid solution of C.I. Pigment Red 202 and C.I. Pigment Violet 19, product name: “Cinquasia Magenta D 4500 J”, manufactured by Sun Chemical)
C.I. Pigment Yellow 74 (product name: “Fast Yellow 011”, manufactured by Dainichiseika Color & Chemicals Mfg. Co., Ltd.)

TABLE 1
Composition of pigment dispersion liquid

| | Pigment dispersion liquid | | | |
|---|---|---|---|---|
| | 2 | 3 | 4 | 5 |
| Carbon black | 20.0 | | | |
| C.I. Pigment Blue 15:3 | | 20.0 | | |
| Magenta solid solution pigment | | | 20.0 | |
| C.I. Pigment Yellow 74 | | | | 20.0 |
| Aqueous solution of acrylic resin | 6.0 | 6.0 | 6.0 | 6.0 |
| Ion-exchanged water | 74.0 | 74.0 | 74.0 | 74.0 |
| Content of pigment (%) | 20.0 | 20.0 | 20.0 | 20.0 |
| Content of resin (%) | 1.2 | 1.2 | 1.2 | 1.2 |

### (Pigment Dispersion Liquid 6)

A self-dispersible pigment manufactured by Toyo Ink Co., Ltd. (product name: “KM-9036”) was used as a pigment dispersion liquid 6. The pigment content of the pigment dispersion liquid 6 was 10.0%. In the preparation of the pigment dispersion liquid 6, reference was made to Japanese Patent Laid-Open No. 2007-136772.

### (Pigment Dispersion Liquid 7)

A pigment dispersion liquid 7 having a pigment content of 10.0% was prepared by the same method as the method described in “(1) Production of Pigment Dispersion Liquid” in “Black Ink” in Examples of Japanese Patent Laid-Open No. 2024-075146.

### (Pigment Dispersion Liquid 8)

A pigment dispersion liquid 8 having a pigment content of 10.0% was prepared by the same method as the method described in “Preparation of Pigment-containing Polymer Fine Particle Aqueous Dispersion” in “Production Example 2 Ink” in Examples of Japanese Patent Laid-Open No. 2007-136772. C.I. Pigment Blue 15:3 was used as a pigment.

### (Pigment Dispersion Liquid 9)

A pigment dispersion liquid 9 having a pigment content of 10.0% was prepared by the same method as the method described in “Preparation of Pigment-containing Polymer Fine Particle Aqueous Dispersion” in “Production Example 2 Ink” in Examples of Japanese Patent Laid-Open No. 2007-136772. C.I. Pigment Red 122 was used as a pigment.

### (Pigment Dispersion Liquid 10)

A pigment dispersion liquid 10 having a pigment content of 10.0% was prepared by the same method as the method described in “Preparation of Pigment-containing Polymer Fine Particle Aqueous Dispersion” in “Production Example 2 Ink” in Examples of Japanese Patent Laid-Open No. 2007-136772. C.I. Pigment Yellow 74 was used as a pigment.

### <Preparation of Resin Aqueous Solution>

### (Aqueous Solution of Resin 1)

A resin 1 (acrylic resin), which was a water-soluble resin having an acid value of 150 mgKOH/g and a weight-average molecular weight of 8,000, was synthesized by copolymerizing 80.7 parts of styrene and 19.3 parts of acrylic acid by a conventional method. The resultant resin 1 was dissolved in ion-exchanged water by adding potassium hydroxide in an equimolar amount to its acid value to provide an aqueous solution of the resin 1 in which the content of the resin 1 (solid content) was 20.0%.

### (Aqueous Solution of Resin 2)

A four-necked flask including a stirring machine, a temperature gauge, a nitrogen gas-introducing tube and a reflux tube was prepared. 32.9 Parts of isophorone diisocyanate, 51.9 parts of polypropylene glycol (number-average molecular weight: 2,000), 15.7 parts of dimethylolpropionic acid and 300.0 parts of methyl ethyl ketone were loaded into the four-necked flask. Then, the contents were caused to react with each other at 80° C. for 6 hours under a nitrogen gas atmosphere. Next, 0.9 parts of ethylenediamine was added thereto, and the contents were caused to react with each other at 80° C. until a product having a predetermined weight-average molecular weight was obtained to provide a reaction liquid. After the resultant reaction liquid had been cooled to 40° C., ion-exchanged water was added thereto. While the mixture was stirred with a homomixer at a high speed, a potassium hydroxide aqueous solution was added thereto to provide a liquid. Methyl ethyl ketone was evaporated from the resultant liquid by heating under reduced pressure. Thus, an aqueous solution of a resin 2 serving as a urethane resin, in which the content of the resin 2 (solid content) was 10.0%, was obtained. The acid value of the resin 2 was 65 mgKOH/g.

### <Preparation of Aqueous Dispersion of Resin Particle>

### (Aqueous Dispersion of Resin Particle 1)

74.0 Parts of ion-exchanged water and 0.2 parts of potassium persulfate were loaded into a four-necked flask including a stirring machine, a reflux condenser and a nitrogen gas-introducing tube, and the contents were mixed. In addition, 24.0 parts of ethyl methacrylate, 1.5 parts of methacrylic acid and 0.3 parts of a reactive surfactant were mixed to prepare an emulsion. A product available under the product name “ADEKA REASOAP ER20” (manufactured by ADEKA Corporation, nonionic surfactant) was used as the reactive surfactant. The prepared emulsion was added dropwise into the above-mentioned four-necked flask over 1 hour under a nitrogen atmosphere. While the mixture was stirred at 80° C., a polymerization reaction was performed for 2 hours. After cooling to 25° C., ion-exchanged water and an aqueous solution containing potassium hydroxide in an equimolar amount to the acid value of a resin particle were added to prepare an aqueous dispersion of a resin particle 1 in which the content of the resin particle was 40.0%.

### (Aqueous Dispersion of Resin Particle 2)

An aqueous dispersion of a resin particle 2 having a resin content of 10.0% was prepared by the same method as the method described in “(2) Production of Resin Fine Particle Dispersion Liquid” in “Black Ink” in Examples of Japanese Patent Laid-Open No. 2024-075146.

### <Preparation of Ink>

### (Black Ink)

Black inks (Bk1 to Bk26) were each prepared by mixing and sufficiently stirring the respective components (unit: %) shown in the middle section of Table 2 (Table 2-1 to Table 2-4), followed by filtration with a microfilter (manufactured by FUJIFILM Corporation) having a pore size of 3.0 μm under pressure. In Table 2, numerical values in the parentheses attached to water-soluble organic solvents indicate the boiling points (unit: ° C.) of the water-soluble organic solvents at 1 atm, and numerical values attached to polyethylene glycols indicate number-average molecular weights. The characteristics and the like of the prepared respective inks are shown in the lower section of Table 2.

### (Cyan Ink)

Cyan inks (Cy1 to Cy16) were each prepared by mixing and sufficiently stirring the respective components (unit: %) shown in the middle section of Table 3 (Table 3-1 and Table 3-2), followed by filtration with a microfilter (manufactured by FUJIFILM Corporation) having a pore size of 3.0 μm under pressure. In Table 3, numerical values in the parentheses attached to water-soluble organic solvents indicate the boiling points (unit: ° C.) of the water-soluble organic solvents at 1 atm, and numerical values attached to polyethylene glycols indicate number-average molecular weights. The characteristics and the like of the prepared respective inks are shown in the lower section of Table 3.

### (Magenta Ink)

Magenta inks (Ma1 to Ma18) were each prepared by mixing and sufficiently stirring the respective components (unit: %) shown in the middle section of Table 4 (Table 4-1 and Table 4-2), followed by filtration with a microfilter (manufactured by FUJIFILM Corporation) having a pore size of 3.0 μm under pressure. In Table 4, numerical values in the parentheses attached to water-soluble organic solvents indicate the boiling points (unit: ° C.) of the water-soluble organic solvents at 1 atm, and numerical values attached to polyethylene glycols indicate number-average molecular weights. The characteristics and the like of the prepared respective inks are shown in the lower section of Table 4.

### (Yellow Ink)

Yellow inks (Ye1 to Ye16) were each prepared by mixing and sufficiently stirring the respective components (unit: %) shown in the middle section of Table 5 (Table 5-1 and Table 5-2), followed by filtration with a microfilter (manufactured by FUJIFILM Corporation) having a pore size of 3.0 μm under pressure. In Table 5, numerical values in the parentheses attached to water-soluble organic solvents indicate the boiling points (unit: ° C.) of the water-soluble organic solvents at 1 atm, and numerical values attached to polyethylene glycols indicate number-average molecular weights. The characteristics and the like of the prepared respective inks are shown in the lower section of Table 5.

The details of the components in Table 2 and Table 3 to Table 5 are shown below.
Acetylenol E60: acetylene glycol-based surfactant, manufactured by Kawaken Fine Chemicals Co., Ltd.
Silicone-based defoaming agent: silicone-based surfactant, product name: “KS508”, manufactured by Shin-Etsu Chemical Co., Ltd.
Proxel: preservative, product name: “Proxel GXL”, manufactured by Arch Chemicals, Inc.

TABLE 2-1
Composition and characteristics of black ink

| | Black ink | | | | | | |
|---|---|---|---|---|---|---|---|
| | Bk1 | Bk2 | Bk3 | Bk4 | Bk5 | Bk6 | Bk7 |
| Pigment dispersion liquid 1 | 30.0 | | 30.0 | 30.0 | 30.0 | 30.0 | 30.0 |
| Pigment dispersion liquid 2 | | 30.0 | | | | | |
| Pigment dispersion liquid 6 | | | | | | | |
| Pigment dispersion liquid 7 | | | | | | | |
| Aqueous solution of resin 1 | | | 15.0 | | | | |
| Aqueous solution of resin 2 | | | | 15.0 | | | |
| Aqueous dispersion of resin particle 1 | 10.0 | 10.0 | 10.0 | 10.0 | 10.0 | 10.0 | 10.0 |
| Aqueous dispersion of resin particle 2 | | | | | | | |
| Glycerin (290) | 16.0 | 16.0 | 16.0 | 16.0 | | | |
| Triethylene glycol (285) | | | | | 16.0 | | |
| Triethylene glycol monobutyl ether (278) | | | | | | 16.0 | |
| Polyethylene glycol 200 (250) | | | | | | | 16.0 |
| Polyethylene glycol 600 (250) | 4.0 | 4.0 | 4.0 | 4.0 | 4.0 | 4.0 | 4.0 |
| 2-Pyrrolidone (245) | | | | | | | |
| 2-Ethyl-1,3-hexanediol (244) | | | | | | | |
| 2-Methyl-1,3-propanediol (230) | | | | | 1.0 | | |
| 1,2-Hexanediol (224) | | | | | | | 1.0 |
| 1,3-Butanediol (207) | 1.0 | 1.0 | 1.0 | 1.0 | | 1.0 | |
| Ethylene glycol (197) | | | | | | | |
| Acetylenol E60 | 0.5 | 0.5 | 0.5 | 0.5 | 0.5 | 0.5 | 0.5 |
| Silicone-based defoaming agent | | | | | | | |
| Proxel | 0.2 | 0.2 | 0.2 | 0.2 | 0.2 | 0.2 | 0.2 |
| Ion-exchanged water | 38.3 | 38.3 | 23.3 | 23.3 | 38.3 | 38.3 | 38.3 |
| Content Ak of first water-soluble | 20.0 | 20.0 | 20.0 | 20.0 | 20.0 | 20.0 | 20.0 |
| organic solvent (%) | | | | | | | |
| Content Bk of second water-soluble | 1.0 | 1.0 | 1.0 | 1.0 | 1.0 | 1.0 | 1.0 |
| organic solvent (%) | | | | | | | |
| Content Pk of pigment (%) | 6.0 | 6.0 | 6.0 | 6.0 | 6.0 | 6.0 | 6.0 |
| Value of Ak/Bk (times) | 20.0 | 20.0 | 20.0 | 20.0 | 20.0 | 20.0 | 20.0 |
| Value of Ak/Pk (times) | 3.3 | 3.3 | 3.3 | 3.3 | 3.3 | 3.3 | 3.3 |

TABLE 2-2
Composition and characteristics of black ink

| | Black ink | | | | | | |
|---|---|---|---|---|---|---|---|
| | Bk8 | Bk9 | Bk10 | Bk11 | Bk12 | Bk13 | Bk14 |
| Pigment dispersion liquid 1 | 30.0 | 30.0 | 30.0 | 20.0 | 25.0 | 50.0 | 30.0 |
| Pigment dispersion liquid 2 | | | | | | | |
| Pigment dispersion liquid 6 | | | | | | | |
| Pigment dispersion liquid 7 | | | | | | | |
| Aqueous solution of resin 1 | | | | | | | |
| Aqueous solution of resin 2 | | | | | | | |
| Aqueous dispersion of resin particle 1 | 10.0 | 10.0 | 10.0 | 10.0 | 10.0 | 10.0 | 10.0 |
| Aqueous dispersion of resin particle 2 | | | | | | | |
| Glycerin (290) | 4.0 | 11.0 | 26.0 | 16.0 | 16.0 | 21.0 | 8.0 |
| Triethylene glycol (285) | | | | | | | |
| Triethylene glycol monobutyl ether (278) | | | | | | | |
| Polyethylene glycol 200 (250) | | | | | | | |
| Polyethylene glycol 600 (250) | 16.0 | 4.0 | 4.0 | 4.0 | 4.0 | 4.0 | 4.0 |
| 2-Pyrrolidone (245) | | | | | | | |
| 2-Ethyl-1,3-hexanediol (244) | | | | | | | |
| 2-Methyl-1,3-propanediol (230) | | | | | | | |
| 1,2-Hexanediol (224) | | | | | | | |
| 1,3-Butanediol (207) | | 15.0 | 1.0 | 1.0 | 1.0 | 1.0 | 1.0 |
| Ethylene glycol (197) | 1.0 | | | | | | |
| Acetylenol E60 | 0.5 | 0.5 | 0.5 | 0.5 | 0.5 | 0.5 | 0.5 |
| Silicone-based defoaming agent | | | | | | | |
| Proxel | 0.2 | 0.2 | 0.2 | 0.2 | 0.2 | 0.2 | 0.2 |
| Ion-exchanged water | 38.3 | 29.3 | 28.3 | 48.3 | 43.3 | 13.3 | 46.3 |
| Content Ak of first water-soluble | 20.0 | 15.0 | 30.0 | 20.0 | 20.0 | 25.0 | 12.0 |
| organic solvent (%) | | | | | | | |
| Content Bk of second water-soluble | 1.0 | 15.0 | 1.0 | 1.0 | 1.0 | 1.0 | 1.0 |
| organic solvent (%) | | | | | | | |
| Content Pk of pigment (%) | 6.0 | 6.0 | 6.0 | 4.0 | 5.0 | 10.0 | 6.0 |
| Value of Ak/Bk (times) | 20.0 | 1.0 | 30.0 | 20.0 | 20.0 | 25.0 | 12.0 |
| Value of Ak/Pk (times) | 3.3 | 2.5 | 5.0 | 5.0 | 4.0 | 2.5 | 2.0 |

TABLE 2-3
Composition and characteristics of black ink

| | Black ink | | | | | | |
|---|---|---|---|---|---|---|---|
| | Bk15 | Bk16 | Bk17 | Bk18 | Bk19 | Bk20 | Bk21 |
| Pigment dispersion liquid 1 | 30.0 | 30.0 | 30.0 | 30.0 | 20.0 | 30.0 | 30.0 |
| Pigment dispersion liquid 2 | | | | | | | |
| Pigment dispersion liquid 6 | | | | | | | |
| Pigment dispersion liquid 7 | | | | | | | |
| Aqueous solution of resin 1 | | | | | | | |
| Aqueous solution of resin 2 | | | | | | | |
| Aqueous dispersion of resin particle 1 | 10.0 | | 10.0 | 10.0 | 10.0 | 10.0 | 10.0 |
| Aqueous dispersion of resin particle 2 | | | | | | | |
| Glycerin (290) | 8.6 | 16.0 | 20.0 | 11.0 | 4.0 | 1.0 | |
| Triethylene glycol (285) | | | | | | | |
| Triethylene glycol monobutyl ether (278) | | | | | | | |
| Polyethylene glycol 200 (250) | | | | | | | |
| Polyethylene glycol 600 (250) | 4.0 | 4.0 | | 4.0 | 4.0 | 4.0 | |
| 2-Pyrrolidone (245) | | | | | | | |
| 2-Ethyl-1,3-hexanediol (244) | | | | | | | |
| 2-Methyl-1,3-propanediol (230) | | | | | | | |
| 1,2-Hexanediol (224) | | | | | | | |
| 1,3-Butanediol (207) | 1.0 | 1.0 | 1.0 | 3.0 | 8.0 | 15.0 | 20.0 |
| Ethylene glycol (197) | | | | | | | |
| Acetylenol E60 | 0.5 | 0.5 | 0.5 | 0.5 | 0.5 | | |
| Silicone-based defoaming agent | | | | | | | |
| Proxel | 0.2 | 0.2 | 0.2 | 0.2 | 0.2 | 0.2 | 0.2 |
| Ion-exchanged water | 45.7 | 48.3 | 38.3 | 41.3 | 53.3 | 39.8 | 39.8 |
| Content Ak of first water-soluble | 12.6 | 20.0 | 20.0 | 15.0 | 8.0 | 5.0 | 0.0 |
| organic solvent (%) | | | | | | | |
| Content Bk of second water-soluble | 1.0 | 1.0 | 1.0 | 3.0 | 8.0 | 15.0 | 20.0 |
| organic solvent (%) | | | | | | | |
| Content Pk of pigment (%) | 6.0 | 6.0 | 6.0 | 6.0 | 4.0 | 6.0 | 6.0 |
| Value of Ak/Bk (times) | 12.6 | 20.0 | 20.0 | 5.0 | 1.0 | 0.3 | 0.0 |
| Value of Ak/Pk (times) | 2.1 | 3.3 | 3.3 | 2.5 | 2.0 | 0.8 | 0.0 |

TABLE 2-4
Composition and characteristics of black ink

| | Black ink | | | | |
|---|---|---|---|---|---|
| | Bk22 | Bk23 | Bk24 | Bk25 | Bk26 |
| Pigment dispersion liquid 1 | 30.0 | 30.0 | | | |
| Pigment dispersion liquid 2 | | | | | |
| Pigment dispersion liquid 6 | | | 50.0 | | 50.0 |
| Pigment dispersion liquid 7 | | | | 50.0 | |
| Aqueous solution of resin 1 | | | | | |
| Aqueous solution of resin 2 | | | | | |
| Aqueous dispersion of resin particle 1 | 10.0 | 10.0 | | | |
| Aqueous dispersion of resin particle 2 | | | | 10.0 | |
| Glycerin (290) | 16.0 | 16.0 | 10.0 | | 7.3 |
| Triethylene glycol (285) | | | | | 22.0 |
| Triethylene glycol monobutyl ether | | | | | |
| (278) | | | | | |
| Polyethylene glycol 200 (250) | | | | | |
| Polyethylene glycol 600 (250) | 4.0 | 4.0 | | | |
| 2-Pyrrolidone (245) | | | 2.0 | 5.0 | |
| 2-Ethyl-1,3-hexanediol (244) | | | 2.0 | | 2.0 |
| 2-Methyl-1,3-propanediol (230) | | | | 15.0 | |
| 1,2-Hexanediol (224) | | | | | |
| 1,3-Butanediol (207) | | 0.5 | 15.0 | | |
| Ethylene glycol (197) | | | | | |
| Acetylenol E60 | | | 1.0 | | 1.0 |
| Silicone-based defoaming agent | | | 0.1 | | 0.1 |
| Proxel | 0.2 | 0.2 | | | |
| Ion-exchanged water | 39.8 | 39.3 | 19.9 | 20.0 | 17.6 |
| Content Ak of first water-soluble | 20.0 | 20.0 | 10.0 | 0.0 | 29.3 |
| organic solvent (%) | | | | | |
| Content Bk of second water-soluble | 0.0 | 0.5 | 19.0 | 20.0 | 2.0 |
| organic solvent (%) | | | | | |
| Content Pk of pigment (%) | 5.0 | 6.0 | 5.0 | 5.0 | 5.0 |
| Value of Ak/Bk (times) | — | 40.0 | 0.5 | 0.0 | 14.7 |
| Value of Ak/Pk (times) | 3.3 | 3.3 | 2.0 | 0.0 | 5.9 |

TABLE 3-1
Composition and characteristics of cyan ink

| | Cyan ink | | | | | | | |
|---|---|---|---|---|---|---|---|---|
| | Cy1 | Cy2 | Cy3 | Cy4 | Cy5 | Cy6 | Cy7 | Cy8 |
| Pigment dispersion liquid 3 | 30.0 | 30.0 | 30.0 | 30.0 | 30.0 | 30.0 | 30.0 | 30.0 |
| Pigment dispersion liquid 8 | | | | | | | | |
| Aqueous dispersion of resin particle 1 | 10.0 | 10.0 | 10.0 | | 10.0 | 10.0 | 10.0 | 10.0 |
| Aqueous dispersion of resin particle 2 | | | | | | | | |
| Glycerin (290) | 10.0 | 7.0 | 12.0 | 10.0 | 18.0 | 10.0 | 7.0 | 12.0 |
| Triethylene glycol (285) | | | | | | | | |
| Polyethylene glycol 600 (250) | 8.0 | 8.0 | 8.0 | 8.0 | | 8.0 | 8.0 | 8.0 |
| 2-Pyrrolidone (245) | | | | | | 1.0 | | |
| 2,2,4-Trimethyl-1,3-pentanediol (232) | | | | | | | | |
| 2-Methyl-1,3-propanediol (230) | | | | | | | | |
| 1,3-Butanediol (207) | 1.0 | 15.0 | 1.0 | 1.0 | 1.0 | | 3.0 | 2.5 |
| Acetylenol E60 | 0.5 | 0.5 | 0.5 | 0.5 | 0.5 | 0.5 | 0.5 | 0.5 |
| Silicone-based defoaming agent | | | | | | | | |
| Proxel | 0.2 | 0.2 | 0.2 | 0.2 | 0.2 | 0.2 | 0.2 | 0.2 |
| Ion-exchanged water | 40.3 | 29.3 | 38.3 | 50.3 | 40.3 | 40.3 | 41.3 | 36.8 |
| Content Ac of first water-soluble | 18.0 | 15.0 | 20.0 | 18.0 | 18.0 | 18.0 | 15.0 | 20.0 |
| organic solvent (%) | | | | | | | | |
| Content Bc of second water-soluble | 1.0 | 15.0 | 1.0 | 1.0 | 1.0 | 1.0 | 3.0 | 2.5 |
| organic solvent (%) | | | | | | | | |
| Content Pc of pigment (%) | 6.0 | 6.0 | 6.0 | 6.0 | 6.0 | 6.0 | 6.0 | 6.0 |
| Value of Ac/Bc (times) | 18.0 | 1.0 | 20.0 | 18.0 | 18.0 | 18.0 | 5.0 | 8.0 |
| Value of Ac/Pc (times) | 3.0 | 2.5 | 3.3 | 3.0 | 3.0 | 3.0 | 2.5 | 3.3 |

TABLE 3-2
Composition and characteristics of cyan ink

| | Cyan ink | | | | | | | |
|---|---|---|---|---|---|---|---|---|
| | Cy9 | Cy10 | Cy11 | Cy12 | Cy13 | Cy14 | Cy15 | Cy16 |
| Pigment dispersion liquid 3 | 20.0 | 30.0 | 30.0 | 30.0 | 30.0 | | 20.0 | |
| Pigment dispersion liquid 8 | | | | | | 40.0 | | 50.0 |
| Aqueous dispersion of resin particle 1 | 10.0 | 10.0 | 10.0 | 10.0 | 10.0 | | | |
| Aqueous dispersion of resin particle 2 | | | | | | | 10.0 | |
| Glycerin (290) | | | | 12.0 | 12.0 | 8.0 | | 25.0 |
| Triethylene glycol (285) | | | | | | | | 9.0 |
| Polyethylene glycol 600 (250) | 8.0 | 5.0 | | 8.0 | 8.0 | | | |
| 2-Pyrrolidone (245) | | | | | | | 5.0 | |
| 2,2,4-Trimethyl-1,3-pentanediol (232) | | | | | | 2.0 | | 2.0 |
| 2-Methyl-1,3-propanediol (230) | | | | | | | 15.0 | |
| 1,3-Butanediol (207) | 0.6 | 15.0 | 20.0 | | 0.5 | 20.0 | | |
| Acetylenol E60 | 0.5 | 0.5 | 0.5 | 0.5 | 0.5 | 1.5 | 0.5 | 1.5 |
| Silicone-based defoaming agent | | | | | | 0.1 | | 0.1 |
| Proxel | 0.2 | 0.2 | 0.2 | 0.2 | 0.2 | | | |
| Ion-exchanged water | 60.7 | 39.3 | 39.3 | 39.3 | 38.8 | 28.4 | 49.5 | 12.4 |
| Content Ac of first water-soluble | 8.0 | 5.0 | 0.0 | 20.0 | 20.0 | 8.0 | 0.0 | 34.0 |
| organic solvent (%) | | | | | | | | |
| Content Bc of second water-soluble | 0.6 | 15.0 | 20.0 | 0.0 | 0.5 | 22.0 | 20.0 | 2.0 |
| organic solvent (%) | | | | | | | | |
| Content Pc of pigment (%) | 4.0 | 6.0 | 6.0 | 6.0 | 6.0 | 4.0 | 4.0 | 5.0 |
| Value of Ac/Bc (times) | 13.0 | 0.3 | 0.0 | — | 40.0 | 0.4 | 0.0 | 17.0 |
| Value of Ac/Pc (times) | 2.0 | 0.8 | 0.0 | 3.3 | 3.3 | 2.0 | 0.0 | 6.8 |

TABLE 4-1
Composition and characteristics of magenta ink

| | Magenta ink | | | | | | | | |
|---|---|---|---|---|---|---|---|---|---|
| | Ma1 | Ma2 | Ma3 | Ma4 | Ma5 | Ma6 | Ma7 | Ma8 | Ma9 |
| Pigment dispersion liquid 4 | 30.0 | 30.0 | 30.0 | 30.0 | 30.0 | 30.0 | 30.0 | 30.0 | 20.0 |
| Pigment dispersion liquid 9 | | | | | | | | | |
| Aqueous dispersion of resin particle 1 | 10.0 | 10.0 | 10.0 | | 10.0 | 10.0 | 10.0 | 10.0 | 10.0 |
| Aqueous dispersion of resin particle 2 | | | | | | | | | |
| Glycerin (290) | 10.0 | 7.0 | 12.0 | 10.0 | 18.0 | 10.0 | 7.0 | 13.0 | |
| Triethylene glycol (285) | | | | | | | | | |
| Polyethylene glycol 600 (250) | 8.0 | 8.0 | 8.0 | 8.0 | | 8.0 | 8.0 | 8.0 | 8.0 |
| 2-Pyrrolidone (245) | | | | | | 1.0 | | | |
| 2,2,4-Trimethyl-1,3-pentanediol (232) | | | | | | | | | |
| 2-Methyl-1,3-propanediol (230) | | | | | | | | | |
| 1,3-Butanediol (207) | 1.0 | 15.0 | 1.0 | 1.0 | 1.0 | | 3.0 | 1.5 | 1.1 |
| Acetylenol E60 | 0.5 | 0.5 | 0.5 | 0.5 | 0.5 | 0.5 | 0.5 | 0.5 | 0.5 |
| Silicone-based defoaming agent | | | | | | | | | |
| Proxel | 0.2 | 0.2 | 0.2 | 0.2 | 0.2 | 0.2 | 0.2 | 0.2 | 0.2 |
| Ion-exchanged water | 40.3 | 29.3 | 38.3 | 50.3 | 40.3 | 40.3 | 41.3 | 36.8 | 60.2 |
| Content Am of first water-soluble | 18.0 | 15.0 | 20.0 | 18.0 | 18.0 | 18.0 | 15.0 | 21.0 | 8.0 |
| organic solvent (%) | | | | | | | | | |
| Content Bm of second water-soluble | 1.0 | 15.0 | 1.0 | 1.0 | 1.0 | 1.0 | 3.0 | 1.5 | 1.1 |
| organic solvent (%) | | | | | | | | | |
| Content Pm of pigment (%) | 6.0 | 6.0 | 6.0 | 6.0 | 6.0 | 6.0 | 6.0 | 6.0 | 4.0 |
| Value of Am/Bm (times) | 18.0 | 1.0 | 20.0 | 18.0 | 18.0 | 18.0 | 5.0 | 14.0 | 7.0 |
| Value of Am/Pm (times) | 3.0 | 2.5 | 3.3 | 3.0 | 3.0 | 3.0 | 2.5 | 3.5 | 2.0 |

TABLE 4-2
Composition and characteristics of magenta ink

| | Magenta ink | | | | | | | | |
|---|---|---|---|---|---|---|---|---|---|
| | Ma10 | Ma11 | Ma12 | Ma13 | Ma14 | Ma15 | Ma16 | Ma17 | Ma18 |
| Pigment dispersion liquid 4 | 30.0 | 30.0 | 30.0 | 30.0 | 30.0 | | 40.0 | | 30.0 |
| Pigment dispersion liquid 9 | | | | | | 50.0 | | 50.0 | |
| Aqueous dispersion of resin particle 1 | 10.0 | 10.0 | 10.0 | 10.0 | 10.0 | | | | |
| Aqueous dispersion of resin particle 2 | | | | | | | 10.0 | | |
| Glycerin (290) | | | 12.0 | | 12.0 | 10.0 | | 7.3 | 5.0 |
| Triethylene glycol (285) | | | | | | | | 22.0 | |
| Polyethylene glycol 600 (250) | 5.0 | | 8.0 | 5.0 | 8.0 | | | | |
| 2-Pyrrolidone (245) | | | | | | | 5.0 | | |
| 2,2,4-Trimethyl-1,3-pentanediol (232) | | | | | | 2.0 | | | |
| 2-Methyl-1,3-propanediol (230) | | | | | | | 15.0 | 2.0 | |
| 1,3-Butanediol (207) | 15.0 | 20.0 | | 15.0 | 0.5 | 18.0 | | | 15.0 |
| Acetylenol E60 | 0.5 | 0.5 | 0.5 | 0.5 | 0.5 | 1.5 | 0.5 | 1.5 | 0.5 |
| Silicone-based defoaming agent | | | | | | 0.1 | | 0.1 | |
| Proxel | 0.2 | 0.2 | 0.2 | 0.2 | 0.2 | | | | 0.2 |
| Ion-exchanged water | 39.3 | 39.3 | 39.3 | 39.3 | 38.8 | 18.4 | 29.5 | 17.1 | 49.3 |
| Content Am of first water-soluble | 5.0 | 0.0 | 20.0 | 5.0 | 20.0 | 10.0 | 0.0 | 29.3 | 5.0 |
| organic solvent (%) | | | | | | | | | |
| Content Bm of second water-soluble | 15.0 | 20.0 | 0.0 | 15.0 | 0.5 | 20.0 | 20.0 | 2.0 | 15.0 |
| organic solvent (%) | | | | | | | | | |
| Content Pm of pigment (%) | 6.0 | 6.0 | 6.0 | 6.0 | 6.0 | 5.0 | 8.0 | 5.0 | 6.0 |
| Value of Am/Bm (times) | 0.3 | 0.0 | — | 0.3 | 40.0 | 0.5 | 0.0 | 14.7 | 0.3 |
| Value of Am/Pm (times) | 0.8 | 0.0 | 3.3 | 0.8 | 3.3 | 2.0 | 0.0 | 5.9 | 0.8 |

TABLE 5-1
Composition and characteristics of yellow ink

| | Yellow ink | | | | | | | |
|---|---|---|---|---|---|---|---|---|
| | Ye1 | Ye2 | Ye3 | Ye4 | Ye5 | Ye6 | Ye7 | Ye8 |
| Pigment dispersion liquid 5 | 30.0 | 30.0 | 30.0 | 30.0 | 30.0 | 30.0 | 30.0 | 30.0 |
| Pigment dispersion liquid 10 | | | | | | | | |
| Aqueous dispersion of resin particle 1 | 10.0 | 10.0 | 10.0 | | 10.0 | 10.0 | 10.0 | 10.0 |
| Aqueous dispersion of resin particle 2 | | | | | | | | |
| Glycerin (290) | 7.0 | 7.0 | 12.0 | 7.0 | 15.0 | 7.0 | 12.0 | 12.0 |
| Triethylene glycol (285) | | | | | | | | |
| Polyethylene glycol 600 (250) | 8.0 | 8.0 | 8.0 | 8.0 | | 8.0 | 8.0 | 8.0 |
| 2-Pyrrolidone (245) | | | | | | 5.0 | | |
| 2,2,4-Trimethyl-1,3-pentanediol (232) | | | | | | | | |
| 2-Methy1-1,3-propanediol (230) | | | | | | | | |
| 1,3-Butanediol (207) | 5.0 | 15.0 | 1.0 | 5.0 | 5.0 | | 1.0 | 10.0 |
| Acetylenol E60 | 0.5 | 0.5 | 0.5 | 0.5 | 0.5 | 0.5 | 0.5 | 0.5 |
| Silicone-based defoaming agent | | | | | | | | |
| Proxel | 0.2 | 0.2 | 0.2 | 0.2 | 0.2 | 0.2 | 0.2 | 0.2 |
| Ion-exchanged water | 39.3 | 29.3 | 38.3 | 49.3 | 39.3 | 39.3 | 38.3 | 29.3 |
| Content Ay of first water-soluble | 15.0 | 15.0 | 20.0 | 15.0 | 15.0 | 15.0 | 20.0 | 20.0 |
| organic solvent (%) | | | | | | | | |
| Content By of second water-soluble | 5.0 | 15.0 | 1.0 | 5.0 | 5.0 | 5.0 | 1.0 | 10.0 |
| organic solvent (%) | | | | | | | | |
| Content Py of pigment (%) | 6.0 | 6.0 | 6.0 | 6.0 | 6.0 | 6.0 | 6.0 | 6.0 |
| Value of Ay/By (times) | 3.0 | 1.0 | 20.0 | 3.0 | 3.0 | 3.0 | 20.0 | 2.0 |
| Value of Ay/Py (times) | 2.5 | 2.5 | 3.3 | 2.5 | 2.5 | 2.5 | 3.3 | 3.3 |

TABLE 5-2
Composition and characteristics of yellow ink

| | Yellow ink | | | | | | | |
|---|---|---|---|---|---|---|---|---|
| | Ye9 | Ye10 | Ye11 | Ye12 | Ye13 | Ye14 | Ye15 | Ye16 |
| Pigment dispersion liquid 5 | 20.0 | 30.0 | 30.0 | 30.0 | | 40.0 | | 30.0 |
| Pigment dispersion liquid 10 | | | | | 40.0 | | 50.0 | |
| Aqueous dispersion of resin particle 1 | 10.0 | 10.0 | 10.0 | 10.0 | | | | |
| Aqueous dispersion of resin particle 2 | | | | | | 10.0 | | |
| Glycerin (290) | | | | 12.0 | 8.0 | | 7.3 | 5.0 |
| Triethylene glycol (285) | | | | | | | 22.0 | |
| Polyethylene glycol 600 (250) | 8.0 | 5.0 | | 8.0 | | | | |
| 2-Pyrrolidone (245) | | | | | | 5.0 | | |
| 2,2,4-Trimethyl-1,3-pentanediol (232) | | | | | 2.0 | | | |
| 2-Methyl-1,3-propanediol (230) | | | | | | 15.0 | 1.8 | |
| 1,3-Butanediol (207) | 0.4 | 15.0 | 20.0 | | 20.0 | | | 15.0 |
| Acetylenol E60 | 0.5 | 0.5 | 0.5 | 0.5 | 1.5 | 0.5 | 1.5 | 0.5 |
| Silicone-based defoaming agent | | | | | 0.1 | | 0.1 | |
| Proxel | 0.2 | 0.2 | 0.2 | 0.2 | | | | 0.2 |
| Ion-exchanged water | 60.9 | 39.3 | 39.3 | 39.3 | 28.4 | 29.5 | 17.3 | 49.3 |
| Content Ay of first water-soluble | 8.0 | 5.0 | 0.0 | 20.0 | 8.0 | 0.0 | 29.3 | 5.0 |
| organic solvent(%) | | | | | | | | |
| Content By of second water-soluble | 0.4 | 15.0 | 20.0 | 0.0 | 22.0 | 20.0 | 1.8 | 15.0 |
| organic solvent (%) | | | | | | | | |
| Content Py of pigment (%) | 4.0 | 6.0 | 6.0 | 6.0 | 4.0 | 8.0 | 5.0 | 6.0 |
| Value of Ay/By (times) | 19.0 | 0.3 | 0.0 | — | 0.4 | 0.0 | 16.3 | 0.3 |
| Value of Ay/Py (times) | 2.0 | 0.8 | 0.0 | 3.3 | 2.0 | 0.0 | 5.9 | 0.8 |

### <Evaluation>

An ink jet recording apparatus (product name: “PIXUS PRO-10S”, manufactured by CANON KABUSHIKI KAISHA) including a recording head for ejecting an ink by thermal energy was prepared. The ink jet recording apparatus was modified to include a first recovery unit 111 and a second recovery unit 112 as illustrated in FIG. 1A and FIG. 1B. The first recovery unit 111 includes a cap 501 for covering the ejection orifice surface of a recording head 110 and performing a recovery operation of discharging an ink by suction (FIG. 4A). The second recovery unit 112 includes a cap 508 free from performing the recovery operation (discharge of the ink) of the recording head 110 (FIG. 4B). When the ejection orifice surface of the recording head 110 is covered with the cap 501, the volume of a space formed by the ejection orifice surface and the cap 501 is 1.8 cm³ (length: 3 cm, width: 2 cm, depth: 0.3 cm). In addition, when the ejection orifice surface of the recording head 110 is covered with the cap 508, the volume of a space formed by the ejection orifice surface and the cap 508 is 1.8 cm³ (length: 3 cm, width: 2 cm, depth: 0.3 cm). The length, the width and the depth correspond to the Y direction, the X direction and the Z direction in FIG. 1A and FIG. 1B, respectively. In this Example, a discharge amount per droplet of the ink was set to 4 ng.

In Comparative Example 2, an ink jet recording apparatus that included the “second recovery unit having the cap through which the ink was not discharged” but was free of the “first recovery unit having the cap through which the ink was discharged” was used. In addition, in Comparative Example 2, as a recovery operation, a predetermined amount of preliminary ejection was performed to a waste ink receiving member different from the cap. In each of Comparative Examples 11 and 12, an ink jet recording apparatus having a recovery unit having the configuration of the “mechanism portion” illustrated in FIG. 3-A of Japanese Patent Laid-Open No. 2005-161834 was used. In this recording apparatus, a combination of a black ink and a cyan ink, and a combination of a magenta ink and a yellow ink are each capped together.

The following respective evaluations were performed by using the prepared respective inks. In the present disclosure, in the evaluation criteria of each evaluation item shown below, the levels “AA”, “A” and “B” were defined as acceptable levels, and the level “C” was defined as an unacceptable level. The evaluation results are shown in Table 7.

### (Sticking Recovery Property)

The respective inks prepared above were each loaded into an ink cartridge and set in an ink jet recording apparatus in the combination shown in Table 6 (Table 6-1 and Table 6-2). After that, the recording head was capped with a cap of a recovery unit (the first recovery unit or the second recovery unit) shown in Table 6. In this state, the ink jet recording apparatus was left to stand for 14 days under an environment at a temperature of 30° C. and a relative humidity of 10%, and then a nozzle check pattern of the recording apparatus (product name: “PIXUS PRO-10S”, manufactured by CANON KABUSHIKI KAISHA) (for Comparative Examples 11 and 12, a pattern with which a similar evaluation can be performed) was recorded. The recorded nozzle check pattern was visually observed. For an ink that was not able to be recorded normally, a recovery operation by suction was performed from a printer driver until the ink became capable of being recorded normally, and its sticking recovery property was evaluated in accordance with the following evaluation criteria.

A: Normal recording was able to be performed without any recovery operation or after the recovery operation had been performed once.

B: Normal recording was able to be performed after the recovery operation had been performed twice.

C: The recovery operation was required to be performed three or more times before normal recording was able to be performed.

### (Suppression of Change in Color Tone)

The respective inks prepared above were each loaded into an ink cartridge and set in the ink jet recording apparatus in the combination shown in Table 6. A recovery operation was performed from a printer driver, and then a vertical ruled line 1 with a width of 5 dots was recorded on an A4-size recording medium (product name: “High Quality Recording Paper HR-101”, manufactured by CANON KABUSHIKI KAISHA). After that, a recording head was capped with a cap of the recovery unit (the first recovery unit or the second recovery unit) shown in Table 6. In this state, the ink jet recording apparatus was left to stand for 3 days under an environment at a temperature of 30° C. and a relative humidity of 10%. Next, the ink jet recording apparatus was placed for 6 hours under an environment at a temperature of 25° C. and a relative humidity of 50%, and then a vertical ruled line 2 with a width of 5 dots was recorded on an A4-size recording medium (product name: “High Quality Recording Paper HR-101”, manufactured by CANON KABUSHIKI KAISHA) to provide a recorded product. The resultant recorded product was observed with a loupe at a magnification of 20 and visually, and the suppression of a change in color tone was evaluated in accordance with the following evaluation criteria.

AA: A color difference between the vertical ruled line 1 and the vertical ruled line 2 was not able to be recognized even in the observation with the loupe.

A: The color difference between the vertical ruled line 1 and the vertical ruled line 2 was not able to be recognized in the visual observation, but the color difference was able to be recognized at the ends of the ruled line 1 and the ruled line 2 in the observation with the loupe.

B: The color difference between the vertical ruled line 1 and the vertical ruled line 2 was not able to be recognized in the visual observation, but the color difference was able to be recognized in the observation with the loupe.

C: The color difference between the vertical ruled line 1 and the vertical ruled line 2 was able to be recognized in the visual observation.

TABLE 6-1
Evaluation conditions

| | | Black ink | | | Cyan ink | | |
|---|---|---|---|---|---|---|---|
| | | | Value of | | | Value of | |
| | | | Ak/Bk | | | Ac/Bc | |
| | | Kind | (times) | Lightness | Kind | (times) | Lightness |
| Example | 1 | Bk1 | 20.0 | 39 | Cy1 | 18.0 | 76 |
| | 2 | Bk2 | 20.0 | 39 | Cy1 | 18.0 | 76 |
| | 3 | Bk3 | 20.0 | 39 | Cy1 | 18.0 | 76 |
| | 4 | Bk4 | 20.0 | 39 | Cy1 | 18.0 | 76 |
| | 5 | Bk5 | 20.0 | 39 | Cy1 | 18.0 | 76 |
| | 6 | Bk6 | 20.0 | 39 | Cy1 | 18.0 | 76 |
| | 7 | Bk7 | 20.0 | 39 | Cy1 | 18.0 | 76 |
| | 8 | Bk8 | 20.0 | 39 | Cy1 | 18.0 | 76 |
| | 9 | Bk9 | 1.0 | 39 | Cy2 | 1.0 | 76 |
| | 10 | Bk10 | 30.0 | 39 | Cy1 | 18.0 | 76 |
| | 11 | Bk1 | 20.0 | 39 | Cy3 | 20.0 | 76 |
| | 12 | Bk11 | 20.0 | 39 | Cy1 | 18.0 | 76 |
| | 13 | Bk12 | 20.0 | 39 | Cy1 | 18.0 | 76 |
| | 14 | Bk13 | 25.0 | 39 | Cy1 | 18.0 | 76 |
| | 15 | Bk14 | 12.0 | 39 | Cy1 | 18.0 | 76 |
| | 16 | Bk15 | 12.6 | 39 | Cy1 | 18.0 | 76 |
| | 17 | Bk1 | 20.0 | 39 | Cy1 | 18.0 | 76 |
| | 18 | Bk16 | 20.0 | 39 | Cy4 | 18.0 | 76 |
| | 19 | Bk17 | 20.0 | 39 | Cy5 | 18.0 | 76 |
| | 20 | Bk8 | 20.0 | 39 | Cy6 | 18.0 | 76 |
| | 21 | Bk18 | 5.0 | 39 | Cy1 | 18.0 | 76 |
| | 22 | Bk1 | 20.0 | 39 | Cy7 | 5.0 | 76 |
| | 23 | Bk1 | 20.0 | 39 | Cy1 | 18.0 | 76 |
| | 24 | Bk1 | 20.0 | 39 | Cy8 | 8.0 | 76 |
| | 25 | Bk19 | 1.0 | 39 | Cy9 | 13.0 | 76 |
| | 26 | Bk19 | 1.0 | 39 | Cy10 | 0.3 | 76 |
| | 27 | Bk20 | 0.3 | 39 | Cy9 | 13.0 | 76 |
| | 28 | Bk20 | 0.3 | 39 | Cy10 | 0.3 | 76 |
| | 29 | Bk20 | 0.3 | 39 | Cy10 | 0.3 | 76 |
| Comparative | 1 | Bk1 | 20.0 | 39 | Cy1 | 18.0 | 76 |
| Example | 2 | Bk1 | 20.0 | 39 | Cy1 | 18.0 | 76 |
| | 3 | Bk21 | 0.0 | 39 | Cy11 | 0.0 | 76 |
| | 4 | Bk22 | — | 39 | Cy12 | — | 76 |
| | 5 | Bk20 | 0.3 | 39 | Cy10 | 0.3 | 76 |
| | 6 | Bk23 | 40.0 | 39 | Cy13 | 40.0 | 76 |
| | 7 | Bk20 | 0.3 | 39 | Cy10 | 0.3 | 76 |
| | 8 | Bk23 | 40.0 | 39 | Cy13 | 40.0 | 76 |
| | 9 | Bk24 | 0.5 | 39 | Cy14 | 0.4 | 76 |
| | 10 | Bk25 | 0.0 | 39 | Cy15 | 0.0 | 76 |
| | 11 | Bk26 | 14.7 | 39 | Cy16 | 17.0 | 76 |
| | 12 | Bk26 | 14.7 | 39 | Cy16 | 17.0 | 76 |

TABLE 6-2
Evaluation conditions

| | | Magenta ink | | | Yellow ink | | | |
|---|---|---|---|---|---|---|---|---|
| | | | Value of | | | Value of | | |
| | | | Am/Bm | | | Ay/By | | Recovery |
| | | Kind | (times) | Lightness | Kind | (times) | Lightness | unit |
| Example | 1 | Ma1 | 18.0 | 68 | Ye1 | 3.0 | 94 | Second |
| | 2 | Ma1 | 18.0 | 68 | Ye1 | 3.0 | 94 | Second |
| | 3 | Ma1 | 18.0 | 68 | Ye1 | 3.0 | 94 | Second |
| | 4 | Ma1 | 18.0 | 68 | Ye1 | 3.0 | 94 | Second |
| | 5 | Ma1 | 18.0 | 68 | Ye1 | 3.0 | 94 | Second |
| | 6 | Ma1 | 18.0 | 68 | Ye1 | 3.0 | 94 | Second |
| | 7 | Ma1 | 18.0 | 68 | Ye1 | 3.0 | 94 | Second |
| | 8 | Ma1 | 18.0 | 68 | Ye1 | 3.0 | 94 | Second |
| | 9 | Ma2 | 1.0 | 68 | Ye2 | 1.0 | 94 | Second |
| | 10 | Ma1 | 18.0 | 68 | Ye1 | 3.0 | 94 | Second |
| | 11 | Ma3 | 20.0 | 68 | Ye3 | 20.0 | 94 | Second |
| | 12 | Ma1 | 18.0 | 68 | Ye1 | 3.0 | 94 | Second |
| | 13 | Ma1 | 18.0 | 68 | Ye1 | 3.0 | 94 | Second |
| | 14 | Ma1 | 18.0 | 68 | Ye1 | 3.0 | 94 | Second |
| | 15 | Ma1 | 18.0 | 68 | Ye1 | 3.0 | 94 | Second |
| | 16 | Ma1 | 18.0 | 68 | Ye1 | 3.0 | 94 | Second |
| | 17 | Ma4 | 18.0 | 68 | Ye1 | 3.0 | 94 | Second |
| | 18 | Ma4 | 18.0 | 68 | Ye4 | 3.0 | 94 | Second |
| | 19 | Ma5 | 18.0 | 68 | Ye5 | 3.0 | 94 | Second |
| | 20 | Ma6 | 18.0 | 68 | Ye6 | 3.0 | 94 | Second |
| | 21 | Ma1 | 18.0 | 68 | Ye7 | 20.0 | 94 | Second |
| | 22 | Ma1 | 18.0 | 68 | Ye7 | 20.0 | 94 | Second |
| | 23 | Ma7 | 5.0 | 68 | Ye7 | 20.0 | 94 | Second |
| | 24 | Ma8 | 14.0 | 68 | Ye8 | 2.0 | 94 | Second |
| | 25 | Ma9 | 7.0 | 68 | Ye9 | 19.0 | 94 | Second |
| | 26 | Ma10 | 0.3 | 68 | Ye10 | 0.3 | 94 | Second |
| | 27 | Ma10 | 0.3 | 68 | Ye10 | 0.3 | 94 | Second |
| | 28 | Ma9 | 7.0 | 68 | Ye10 | 0.3 | 94 | Second |
| | 29 | Ma10 | 0.3 | 68 | Ye9 | 19.0 | 94 | Second |
| Comparative | 1 | Ma1 | 18.0 | 68 | Ye1 | 3.0 | 94 | First |
| Example | 2 | Ma1 | 18.0 | 68 | Ye1 | 3.0 | 94 | Second |
| | 3 | Ma11 | 0.0 | 68 | Ye11 | 0.0 | 94 | Second |
| | 4 | Ma12 | — | 68 | Ye12 | — | 94 | Second |
| | 5 | Ma13 | 0.3 | 68 | Ye10 | 0.3 | 94 | Second |
| | 6 | Ma14 | 40.0 | 68 | Ye12 | 40.0 | 94 | Second |
| | 7 | Ma13 | 0.3 | 68 | Ye10 | 0.3 | 94 | First |
| | 8 | Ma14 | 40.0 | 68 | Ye12 | 40.0 | 94 | First |
| | 9 | Ma15 | 0.5 | 68 | Ye13 | 0.4 | 94 | Second |
| | 10 | Ma16 | 0.0 | 68 | Ye14 | 0.0 | 94 | Second |
| | 11 | Ma17 | 14.7 | 68 | Ye15 | 16.3 | 94 | Second |
| | 12 | Ma18 | 0.3 | 68 | Ye16 | 0.3 | 94 | Second |

TABLE 7
Evaluation results

| | | Sticking recovery | Suppression of change |
|---|---|---|---|
| | | property | in color tone |
| Example | 1 | A | AA |
| | 2 | A | AA |
| | 3 | A | AA |
| | 4 | A | AA |
| | 5 | A | AA |
| | 6 | A | AA |
| | 7 | A | AA |
| | 8 | A | AA |
| | 9 | A | AA |
| | 10 | A | AA |
| | 11 | A | AA |
| | 12 | A | AA |
| | 13 | A | AA |
| | 14 | A | AA |
| | 15 | B | AA |
| | 16 | A | AA |
| | 17 | A | AA |
| | 18 | A | AA |
| | 19 | A | AA |
| | 20 | A | AA |
| | 21 | A | A |
| | 22 | A | A |
| | 23 | A | A |
| | 24 | A | A |
| | 25 | B | B |
| | 26 | B | B |
| | 27 | B | B |
| | 28 | B | B |
| | 29 | B | B |
| Comparative | 1 | C | — |
| Example | 2 | C | A |
| | 3 | C | C |
| | 4 | A | C |
| | 5 | C | C |
| | 6 | A | C |
| | 7 | C | — |
| | 8 | C | — |
| | 9 | C | C |
| | 10 | C | C |
| | 11 | C | — |
| | 12 | C | — |

With regard to Examples 12 to 14, when the images recorded in the section “Evaluation of Suppression of Change in Color Tone” were compared to each other, the image of Example 12 had relatively lower color developability than those of the images of Examples 13 and 14.

According to the present disclosure, the ink jet recording method excellent in sticking recovery property of an ink, the method capable of recording an image in which a change in color tone is suppressed even when a recording apparatus including a downsized recovery mechanism is used after the lapse of a long period of time under a non-recording state, can be provided. In addition, according to the present disclosure, the ink jet recording apparatus to be used in the ink jet recording method can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-024418, filed Feb. 18, 2025, and Japanese Patent Application No. 2026-019420, filed Feb. 9, 2026, which are hereby incorporated by reference herein in their entirety.

What is claimed is:

1. An ink jet recording method comprising recording an image with an ink jet recording apparatus comprising:
an ink set comprising a plurality of aqueous inks comprising a black ink;
a recording head having an ejection orifice surface on which a plurality of ejection orifice arrays for ejecting each of the plurality of aqueous inks is arranged;
a first cap configured to collectively cover the plurality of ejection orifice arrays on the ejection orifice surface and to perform a recovery operation of sucking or pressurizing the aqueous ink; and
a second cap configured to collectively cover the plurality of ejection orifice arrays on the ejection orifice surface, the second cap being free from performing the recovery operation of sucking or pressurizing the aqueous ink,
the recording head being capped with the second cap during non-recording,
wherein a first ink that is at least one kind of aqueous ink out of the plurality of aqueous inks comprises a pigment, a first water-soluble organic solvent having a boiling point of 250° C. or more and a second water-soluble organic solvent having a boiling point of less than 250° C., and
wherein, in the first ink, a content (% by mass) of the first water-soluble organic solvent is 1.0 times or more to 30.0 times or less in terms of mass ratio with respect to a content (% by mass) of the second water-soluble organic solvent.

2. The ink jet recording method according to claim 1, wherein a content (% by mass) of the pigment in the first ink is 5.0% by mass or more with respect to a total mass of the ink.

3. The ink jet recording method according to claim 1, wherein, in the first ink, the content (% by mass) of the first water-soluble organic solvent is 2.1 times or more in terms of mass ratio with respect to a content (% by mass) of the pigment.

4. The ink jet recording method according to claim 1,
wherein each of the plurality of aqueous inks comprises the pigment, the first water-soluble organic solvent having a boiling point of 250° C. or more and the second water-soluble organic solvent having a boiling point of less than 250° C.,
wherein, in each of the plurality of aqueous inks, a content (% by mass) of the first water-soluble organic solvent is 1.0 times or more to 30.0 times or less in terms of mass ratio with respect to a content (% by mass) of the second water-soluble organic solvent, and
wherein a difference in mass ratio of the content (% by mass) of the first water-soluble organic solvent to the content (% by mass) of the second water-soluble organic solvent in at least one combination of the plurality of aqueous inks is more than 5.0 times, and a lightness of an ink having the smaller mass ratio is higher.

5. The ink jet recording method according to claim 1,
wherein each of the plurality of aqueous inks comprises the pigment, the first water-soluble organic solvent having a boiling point of 250° C. or more and the second water-soluble organic solvent having a boiling point of less than 250° C.,
wherein, in each of the plurality of aqueous inks, a content (% by mass) of the first water-soluble organic solvent is 1.0 times or more to 30.0 times or less in terms of mass ratio with respect to a content (% by mass) of the second water-soluble organic solvent, and
wherein a difference between a maximum value and a minimum value of the mass ratios of the content (% by mass) of the first water-soluble organic solvent to the content (% by mass) of the second water-soluble organic solvent of the plurality of aqueous inks is more than 5.0 times, and a lightness of an ink having the smallest mass ratio is highest.

6. The ink jet recording method according to claim 1,
wherein each of the plurality of aqueous inks comprises the pigment, the first water-soluble organic solvent having a boiling point of 250° C. or more and the second water-soluble organic solvent having a boiling point of less than 250° C.,
wherein, in each of the plurality of aqueous inks, a content (% by mass) of the first water-soluble organic solvent is 1.0 times or more to 30.0 times or less in terms of mass ratio with respect to a content (% by mass) of the second water-soluble organic solvent, and
wherein a difference in mass ratio of the content (% by mass) of the first water-soluble organic solvent to the content (% by mass) of the second water-soluble organic solvent in at least one combination of the plurality of aqueous inks is 5.0 times or less.

7. The ink jet recording method according to claim 1,
wherein each of the plurality of aqueous inks comprises the pigment, the first water-soluble organic solvent having a boiling point of 250° C. or more and the second water-soluble organic solvent having a boiling point of less than 250° C.,
wherein, in each of the plurality of aqueous inks, a content (% by mass) of the first water-soluble organic solvent is 1.0 times or more to 30.0 times or less in terms of mass ratio with respect to a content (% by mass) of the second water-soluble organic solvent, and
wherein a difference between a maximum value and a minimum value of the mass ratios of the content (% by mass) of the first water-soluble organic solvent to the content (% by mass) of the second water-soluble organic solvent of the plurality of aqueous inks is 5.0 times or less.

8. An ink jet recording apparatus to be used in an ink jet recording method comprising recording an image with the ink jet recording apparatus, the ink jet recording apparatus comprising:
an ink set comprising a plurality of aqueous inks comprising a black ink;
a recording head having an ejection orifice surface on which a plurality of ejection orifice arrays for ejecting each of the plurality of aqueous inks is arranged;
a first cap configured to collectively cover the plurality of ejection orifice arrays on the ejection orifice surface and to perform a recovery operation of sucking or pressurizing the aqueous ink; and
a second cap configured to collectively cover the plurality of ejection orifice arrays on the ejection orifice surface, the second cap being free from performing the recovery operation of sucking or pressurizing the aqueous ink,
the recording head being capped with the second cap during non-recording,
wherein a first ink that is at least one kind of aqueous ink out of the plurality of aqueous inks comprises a pigment, a first water-soluble organic solvent having a boiling point of 250° C. or more and a second water-soluble organic solvent having a boiling point of less than 250° C., and
wherein, in the first ink, a content (% by mass) of the first water-soluble organic solvent is 1.0 times or more to 30.0 times or less in terms of mass ratio with respect to a content (% by mass) of the second water-soluble organic solvent.
